(19) United States
(12) Patent Application Publication
(10) Pub. No.: US 2025/0119781 A1
(43) Pub. Date: Apr. 10, 2025

(54) METHOD AND APPARATUS FOR CELL SELECTION IN NON-TERRESTRIAL NETWORK

(71) Applicant: ELECTRONICS AND TELECOMMUNICATIONS RESEARCH INSTITUTE, Daejeon (KR)

(72) Inventor: Hee Wook KIM, Daejeon (KR)

(21) Appl. No.: 18/904,881

(22) Filed: Oct. 2, 2024

(30) Foreign Application Priority Data
Oct. 4, 2023 (KR) 10-2023-0131679

(51) Int. Cl. H04W 24/10; G01S 19/25; G01S 19/42

(52) U.S. Cl. CPC H04W 24/10; G01S 19/258; G01S 19/42

(57) ABSTRACT

A method of a terminal may comprise: calculating a first adjusted distance threshold by adjusting a first reference distance threshold of a serving cell, based on information on a first reference location of the serving cell, ephemeris information of a satellite, and a location of the terminal; calculating a second adjusted distance threshold by adjusting a second reference distance threshold of a neighbor cell, based on information on a second reference location of the neighbor cell, the ephemeris information, and the location of the terminal; performing a distance-based measurement reporting process by applying the first adjusted distance threshold and the second adjusted distance threshold; and selecting a cell through the distance-based measurement reporting process.

### CROSS-REFERENCE TO RELATED APPLICATIONS

This application claims priority to Korean Patent Application No. 10-2023-0131679, filed on Oct. 4, 2023, with the Korean Intellectual Property Office (KIPO), the entire contents of which are hereby incorporated by reference.

### BACKGROUND

### 1. Technical Field

The present disclosure relates to a cell selection technique in a non-terrestrial network, and more particularly, to a cell selection technique in a non-terrestrial network, which enables a terminal to select a cell in consideration of a shape and altitude of the cell in a non-terrestrial network.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Such communication network may be a terrestrial network, as it can provide communication services to terminals located on the ground (terrestrial). Recently, the demand for communication services has been increasing not only for terrestrial terminals but also for non-terrestrial objects, such as unmanned aerial vehicles and satellites. To address this, the 3GPP is discussing technologies for non-terrestrial networks (NTNs). Meanwhile, handover methods may be needed in non-terrestrial networks. However, implementing measurement-based handover methods in non-terrestrial networks may be challenging due to small changes in reference signal received power (RSRP) values. In addition, the overhead in the handover methods in non-terrestrial networks may increase due to a high frequency of handovers caused by mobility of low-orbit satellites and occurrence of unnecessary handover events due to the small changes in RSRP values. Furthermore, the handover methods in non-terrestrial networks may lead to frequent radio link failures (RLFs) due to low signal-to-interference-plus-noise ratio (SINR).

### SUMMARY

The present disclosure for resolving the above-described problems is directed to providing a method and an apparatus for cell selection in a non-terrestrial network, which support cell selection of a terminal in consideration of cell shapes and altitudes in the non-terrestrial network.

A cell selection method in a non-terrestrial network, according to a first exemplary embodiment of the present disclosure, as a method of a terminal, may comprise: calculating a first adjusted distance threshold by adjusting a first reference distance threshold of a serving cell, based on information on a first reference location of the serving cell, ephemeris information of a satellite, and a location of the terminal; calculating a second adjusted distance threshold by adjusting a second reference distance threshold of a neighbor cell, based on information on a second reference location of the neighbor cell, the ephemeris information, and the location of the terminal; performing a distance-based measurement reporting process by applying the first adjusted distance threshold and the second adjusted distance threshold; and selecting a cell through the distance-based measurement reporting process.

The method may further comprise: before calculating of the first adjusted distance threshold, receiving, from the satellite, the ephemeris information, information on the first reference location of the serving cell, and information on the first reference distance threshold of the serving cell; and receiving global navigation satellite system (GNSS) signals from a GNSS to calculate the location of the terminal.

The method may further comprise: before calculating of the second adjusted distance threshold, receiving, from the satellite, information on the second reference location of the neighbor cell, the ephemeris information, and information on the second reference distance threshold of the neighbor cell; and receiving GNSS signals from a GNSS to calculate the location of the terminal.

The calculating of the first adjusted distance threshold may comprise: configuring a reference line between the first reference location and the satellite using information on the first reference location and the ephemeris information; configuring a virtual line connecting the first reference location and the location of the terminal; calculating an angle between the reference line and the virtual line; and calculating the first adjusted distance threshold by adjusting the first reference distance threshold based on the calculated angle.

The calculating of the second adjusted distance threshold may comprise: configuring a reference line between the second reference location and the satellite using information on the second reference location and the ephemeris information; configuring a virtual line connecting the second reference location and the location of the terminal; calculating an angle between the reference line and the virtual line; and calculating the second adjusted distance threshold by adjusting the second reference distance threshold based on the calculated angle.

The performing of the distance-based measurement reporting process may comprise: calculating a first distance between the location of the terminal and the first reference location; calculating a second distance between the location of the terminal and the second reference location; determining whether a first value obtained by subtracting a hysteresis value from the first distance exceeds the first adjusted distance threshold; in response to the first value exceeding the first adjusted distance threshold, determining whether a second value obtained by adding the hysteresis value to the second distance is less than the second adjusted distance threshold; and in response to the second value being less than the second adjusted distance threshold, triggering a measurement report event.

The performing of the distance-based measurement reporting process may comprise: recalculating the first distance between the location of the terminal and the first reference location; determining whether a third value obtained by adding the hysteresis value to the recalculated first distance is less than the first adjusted distance threshold; and in response to the third value being less than the first adjusted distance threshold, stopping triggering the measurement report event.

The performing of the distance-based measurement reporting process may comprise: recalculating the second distance between the location of the terminal and the second reference location; determining whether a fourth value obtained by subtracting the hysteresis value from the recalculated second distance exceeds the second adjusted distance threshold; and in response to the fourth value exceeding the first adjusted distance threshold, stopping triggering the measurement report event.

The hysteresis value may vary depending on the location of the terminal.

A cell selection method in a non-terrestrial network, according to a second exemplary embodiment of the present disclosure, as a method of a terminal, may comprise: receiving, from a satellite, information on a first reference location of a serving cell, information on a first reference altitude threshold of the serving cell, information on a second reference location of a neighbor cell, and information on a second reference altitude threshold of the neighbor cell; calculating a first altitude difference between an altitude of the terminal and the first reference location; calculating a second altitude difference between the altitude of the terminal and the second reference location; performing an altitude-based measurement reporting process based on the first reference altitude threshold, the second reference altitude threshold, the first altitude difference, and the second altitude difference; and selecting a cell through the altitude-based measurement reporting process.

The performing of the altitude-based measurement reporting process may comprise: determining whether a first value obtained by subtracting a hysteresis value from the first altitude difference exceeds the first reference altitude threshold; in response to the first value exceeding the first reference altitude threshold, determining whether a second value obtained by adding the hysteresis value to the second altitude difference is less than the second reference altitude threshold; and in response to the second value being less than the second reference altitude threshold, triggering a measurement report event.

The performing of the altitude-based measurement reporting process may comprise: recalculating the first altitude difference between the altitude of the terminal and the first reference location; determining whether a third value obtained by adding the hysteresis value to the recalculated first altitude difference is less than the first reference altitude threshold; and in response to the third value being less than the first reference altitude threshold, stopping triggering the measurement report event.

The performing of the altitude-based measurement reporting process may comprise: recalculating the second altitude difference between the altitude of the terminal and the second reference location; determining whether a fourth value obtained by subtracting the hysteresis value from the recalculated second altitude difference exceeds the second reference altitude threshold; and in response to the fourth value exceeding the first reference altitude threshold, stopping triggering the measurement report event.

The method may further comprise: receiving, from the satellite, ephemeris information of the satellite, wherein the performing of the altitude-based measurement reporting process comprises: configuring a reference altitude line by connecting the first reference location and the satellite using information on the first reference location and the ephemeris information; setting a first adjusted altitude threshold by adjusting the first reference altitude threshold based on an angle between the reference altitude line and a ground and a location of the terminal; setting a second adjusted altitude threshold by adjusting the second reference altitude threshold based on the angle between the reference altitude line and the ground and the location of the terminal; and performing the altitude-based measurement reporting process based on the first adjusted altitude threshold, the second adjusted altitude threshold, the first altitude difference, and the second altitude difference.

The performing of the altitude-based measurement reporting process may comprise: determining whether a first value obtained by subtracting a hysteresis value from the first altitude difference exceeds the first adjusted altitude threshold; in response to the first value exceeding the first adjusted altitude threshold, determining whether a second value obtained by adding the hysteresis value to the second altitude difference is less than the second adjusted altitude threshold; and in response to the second value being less than the second adjusted altitude threshold, triggering a measurement report event.

A cell selection device in a non-terrestrial network, according to a third exemplary embodiment of the present disclosure, as a terminal, may comprise a processor, and the processor may cause the terminal to perform: calculating a first adjusted distance threshold by adjusting a first reference distance threshold of a serving cell, based on information on a first reference location of the serving cell, ephemeris information of a satellite, and a location of the terminal; calculating a second adjusted distance threshold by adjusting a second reference distance threshold of a neighbor cell, based on information on a second reference location of the neighbor cell, the ephemeris information, and the location of the terminal; performing a distance-based measurement reporting process by applying the first adjusted distance threshold and the second adjusted distance threshold; and selecting a cell through the distance-based measurement reporting process.

In the performing of the distance-based measurement reporting process, the processor may cause the terminal to perform: calculating a first distance between the location of the terminal and the first reference location; calculating a second distance between the location of the terminal and the second reference location; determining whether a first value obtained by subtracting a hysteresis value from the first distance exceeds the first adjusted distance threshold; in response to the first value exceeding the first adjusted distance threshold, determining whether a second value obtained by adding the hysteresis value to the second distance is less than the second adjusted distance threshold; and in response to the second value being less than the second adjusted distance threshold, triggering a measurement report event.

In the performing of the distance-based measurement reporting process, the processor may cause the terminal to perform: recalculating the first distance between the location of the terminal and the first reference location; determining whether a third value obtained by adding the hysteresis value to the recalculated first distance is less than the first adjusted distance threshold; and in response to the third value being less than the first adjusted distance threshold, stopping triggering the measurement report event.

In the performing of the distance-based measurement reporting process, the processor may cause the terminal to perform: recalculating the second distance between the location of the terminal and the second reference location; determining whether a fourth value obtained by subtracting the hysteresis value from the recalculated second distance exceeds the second adjusted distance threshold; and in response to the fourth value exceeding the first adjusted distance threshold, stopping triggering the measurement report event.

According to the present disclosure, proposed handover methods can reduce battery consumption of terminals in various non-terrestrial network scenario environments. Additionally, according to the present disclosure, the proposed handover methods can reduce signaling overhead in situations where simultaneous support for mobility of many terminals is required. Furthermore, according to the present disclosure, the proposed handover methods can effectively support mobility of terminals in the air.

### BRIEF DESCRIPTION OF DRAWINGS

FIG. 1 is a conceptual diagram illustrating a first exemplary embodiment of a non-terrestrial network.

FIG. 2 is a conceptual diagram illustrating a second exemplary embodiment of a non-terrestrial network.

FIG. 3 is a block diagram illustrating a first exemplary embodiment of an entity constituting a non-terrestrial network.

FIG. 4A and FIG. 4B are a sequence chart illustrating a first exemplary embodiment of a handover method.

FIG. 5A and FIG. 5B are a sequence chart illustrating a first exemplary embodiment of a conditional handover method.

FIG. 6 is a conceptual diagram illustrating a first exemplary embodiment of a distance-based measurement report event triggering method.

FIG. 7 is a conceptual diagram illustrating a first exemplary embodiment of a cell shape.

FIG. 8 is a conceptual diagram illustrating a second exemplary embodiment of a cell shape.

FIG. 9 is a conceptual diagram illustrating a third exemplary embodiment of a cell shape.

FIG. 10 is a conceptual diagram illustrating a fourth exemplary embodiment of a cell shape.

FIG. 11 is a conceptual diagram illustrating a fifth exemplary embodiment of a cell shape.

FIG. 12 is a conceptual diagram illustrating a sixth exemplary embodiment of a cell shape.

FIG. 13 is a conceptual diagram illustrating a seventh exemplary embodiment of a cell shape.

FIG. 14 is a conceptual diagram illustrating an eighth exemplary embodiment of a cell shape.

FIG. 15 is a conceptual diagram illustrating a ninth exemplary embodiment of a cell shape.

FIG. 16 is a conceptual diagram illustrating a second exemplary embodiment of a distance-based measurement report event triggering method.

FIG. 17 is a conceptual diagram illustrating a tenth exemplary embodiment of a cell shape.

FIG. 18 is a flowchart illustrating a first exemplary embodiment of an altitude-based measurement report event triggering method.

FIG. 19 is a conceptual diagram illustrating an eleventh exemplary embodiment of a cell shape.

FIG. 20 is a flowchart illustrating a second exemplary embodiment of an altitude-based measurement report event triggering method.

FIG. 21 is a conceptual diagram illustrating a twelfth exemplary embodiment of a cell shape.

FIG. 22 is a flowchart illustrating a third exemplary embodiment of an altitude-based measurement report event triggering method.

FIG. 23 is a flowchart illustrating a first exemplary embodiment of a cell selection method in a non-terrestrial network.

FIG. 24 is a flowchart illustrating a second exemplary embodiment of a cell selection method in a non-terrestrial network.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication system may be a non-terrestrial network (NTN), a 4G communication network (e.g. long-term evolution (LTE) communication network), a 5G communication network (e.g. new radio (NR) communication network), a 6G communication network, or the like. The 4G communication network, 5G communication network, and 6G communication network may be classified as terrestrial networks.

The NTN may operate based on the LTE technology and/or the NR technology. The NTN may support communications in frequency bands below 6 GHz as well as in frequency bands above 6 GHz. The 4G communication network may support communications in the frequency band below 6 GHZ. The 5G communication network may support communications in the frequency band below 6 GHz as well as in the frequency band above 6 GHz. The communication network to which the exemplary embodiments according to the present disclosure are applied is not limited to the contents described below, and the exemplary embodiments according to the present disclosure may be applied to various communication networks. Here, the communication network may be used in the same sense as the communication system.

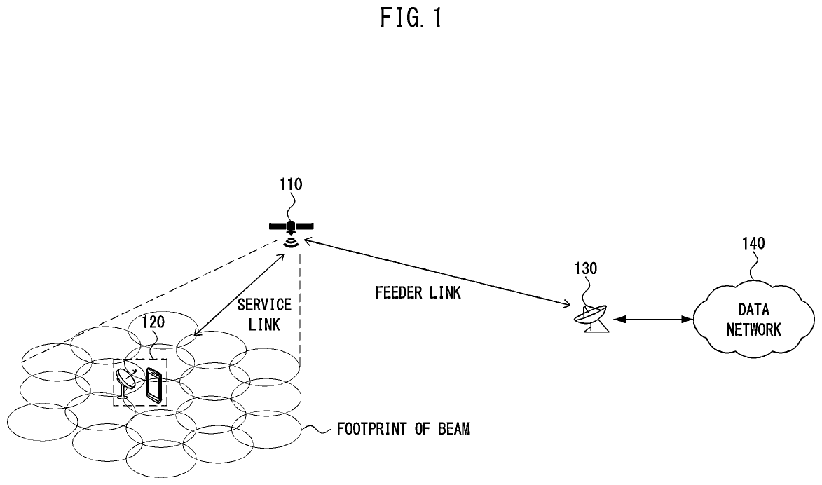

FIG. 1 is a conceptual diagram illustrating a first exemplary embodiment of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite (at an altitude of 300 to 1,500 km), a medium earth orbit (MEO) satellite (at an altitude of 7,000 to 25,000 km), a geostationary earth orbit (GEO) satellite (at an altitude of about 35,786 km), a high elliptical orbit (HEO) satellite, or an unmanned aircraft system (UAS) platform. The UAS platform may include a high altitude platform station (HAPS).

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g. downlink communication and uplink communication) with the satellite 110 using LTE technology and/or NR technology. The communications between the satellite 110 and the communication node 120 may be performed using an NR-Uu interface. When dual connectivity (DC) is supported, the communication node 120 may be connected to other base stations (e.g. base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g. AMF, UPF, SMF, and the like) may be performed based on an NG-C/U interface.

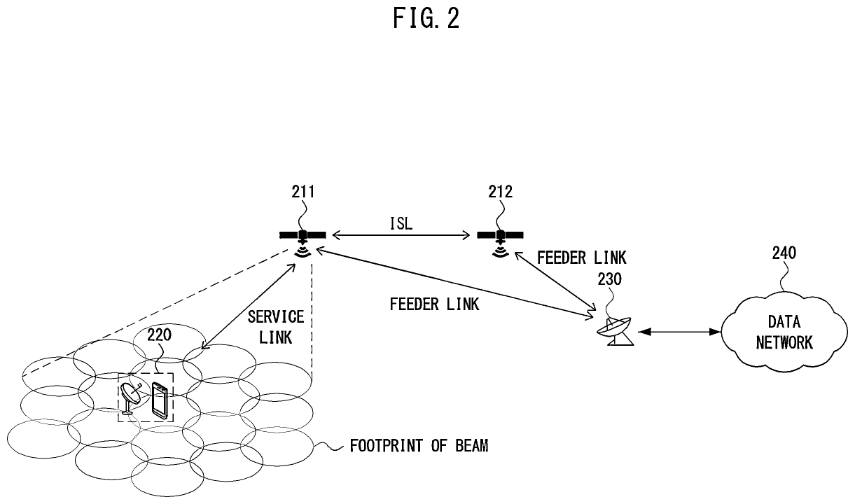

FIG. 2 is a conceptual diagram illustrating a second exemplary embodiment of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink (DL) communication or uplink (UL) communication) with the satellite 211 using LTE technology and/or NR technology. The communications between the satellite 211 and the communication node 220 may be performed using an NR-Uu interface. When DC is supported, the communication node 220 may be connected to other base stations (e.g. base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g. AMF, UPF, SMF, and the like) may be performed based on an NG-C/U interface.

Meanwhile, entities (e.g. satellites, communication nodes, gateways, etc.) constituting the NTNs shown in FIGS. 1 and 2 may be configured as follows.

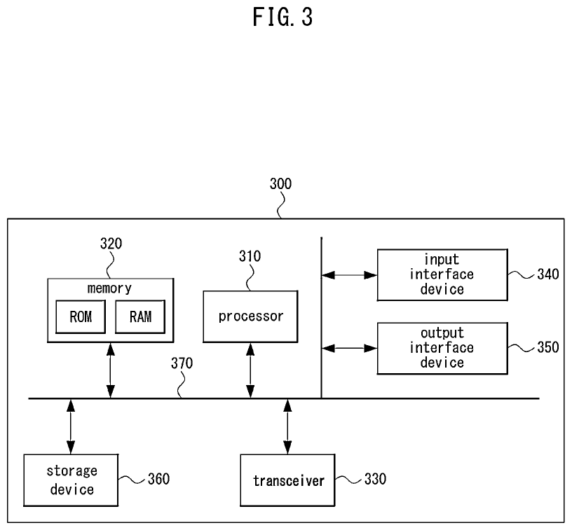

FIG. 3 is a block diagram illustrating a first exemplary embodiment of an entity constituting a non-terrestrial network.

Referring to FIG. 3, an entity 300 may include at least one processor 310, a memory 320, and a transceiver 330 connected to a network to perform communication. In addition, the entity 300 may further include an input interface device 340, an output interface device 350, a storage device 360, and the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, scenarios in the NTN may be defined as shown in Table 1 below.

TABLE 1

| | NTN shown | NTN shown |
|---|---|---|
| | in FIG. 1 | in FIG. 2 |
| GEO | Scenario A | Scenario B |
| LEO (steerable beams) | Scenario C1 | Scenario D1 |
| LEO (beams moving with satellite) | Scenario C2 | Scenario D2 |

When the satellite 110 in the NTN shown in FIG. 1 is a GEO satellite (e.g. a GEO satellite that supports a transparent function), this may be referred to as ‘scenario A’. When the satellites 211 and 212 in the NTN shown in FIG. 2 are GEO satellites (e.g. GEOs that support a regenerative function), this may be referred to as ‘scenario B’.

When the satellite 110 in the NTN shown in FIG. 1 is an LEO satellite with steerable beams, this may be referred to as ‘scenario C1’. When the satellite 110 in the NTN shown in FIG. 1 is an LEO satellite having beams moving with the satellite, this may be referred to as ‘scenario C2’. When the satellites 211 and 212 in the NTN shown in FIG. 2 are LEO satellites with steerable beams, this may be referred to as ‘scenario D1’. When the satellites 211 and 212 in the NTN shown in FIG. 2 are LEO satellites having beams moving with the satellites, this may be referred to as ‘scenario D2’. Parameters for the scenarios defined in Table 1 may be defined as shown in Table 2 below.

TABLE 2

| | Scenarios A and B | | Scenarios C and D |
|---|---|---|---|
| Altitude | 35,786 | km | 600 km |
| | | | 1,200 km |
| Spectrum (service link) | <6 GHz (e.g. 2 GHz) | | |
| | >6 GHz (e.g. DL 20 GHz, UL 30 GHz) | | |
| Maximum channel bandwidth | 30 MHz for band <6 GHz | | |
| capability (service link) | 1 GHz for band >6 GHz | | |
| Maximum distance between | 40,581 | km | 1,932 km (altitude of 600 km) |
| satellite and communication | | | 3,131 km (altitude of 1,200 km) |
| node (e.g. UE) at the minimum | | | |
| elevation angle | | | |
| Maximum round trip delay | Scenario A: 541.46 ms | | Scenario C: (transparent |
| (RTD) | (service and feeder links) | | payload: service and feeder |
| (only propagation delay) | Scenario B: 270.73 ms | | links) |
| | (only service link) | | −5.77 ms (altitude of 60 0 km) |
| | | | −41.77 ms (altitude of 1,200 km) |
| | | | Scenario D: (regenerative |
| | | | payload: only service link) |
| | | | −12.89 ms (altitude of 600 km) |
| | | | −20.89 ms (altitude of 1,200 km) |
| Maximum delay variation | 16 | ms | 4.44 ms (altitude of 600 km) |
| within a single beam | | | 6.44 ms (altitude of 1,200 km) |
| Maximum differential delay | 10.3 | ms | 3.12 ms (altitude of 600 km) |

| | |
|---|---|
| within a cell | 3.18 ms (altitude of 1,200 km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario A | Scenario B | Scenario C1-2 | | Scenario D1-2 | |
|---|---|---|---|---|---|---|
| Satellite altitude | 35,786 km | | 600 km | | | |
| Maximum RTD in a | 541.75 ms | 270.57 ms | 28.41 | ms | 12.88 | ms |
| radio interface between | (worst case) | | | | | |
| base station and UE | | | | | | |
| Minimum RTD in a | 477.14 ms | 238.57 ms | 8 | ms | 4 | ms |
| radio interface between | | | | | | |
| base station and UE | | | | | | |

Meanwhile, it is expected that the mobile communication network beyond 5G will evolve in the direction of combining or cooperating with terrestrial networks and satellite networks (i.e. non-terrestrial networks (NTN)). In the integrated system of terrestrial and satellite networks, commonality between satellite and terrestrial radio interfaces may be very important when considering the cost of the terminals. Accordingly, the standardization of NR-based NTN is actively underway in the 3GPP. Moreover, in the 3GPP, the standardization and research of NTN radio interfaces based on NR/LTE/narrowband Internet of Things (NB-IoT) are progressing with consideration of characteristics such as long round-trip delay times compared to terrestrial mobile communication networks, differences in delay times between terminals, large cell coverage, and significant Doppler shifts between base stations and terminals, reflecting the delay time differences within the cell coverage and the power-limited satellite environment.

Meanwhile, mobility in NR-based TN may be classified into cell reselection in radio resource control (RRC) idle mode and RRC inactive mode, and handover in RRC connected mode. Cell selection in RRC idle mode may require transitions from registration management (RM)-DEREGISTRED to RM-REGISTERED, from connection management (CM)-IDLE to CM-CONNECTED, and from CM-CONNECTED to CM-IDLE. Cell selection in RRC idle mode may have the following principles. Cell reselection in RRC inactive mode may have the same principles as cell selection in RRC idle mode.

(1) A user equipment (UE) non access stratum (NAS) layer may identify a public land mobile network (PLMN) equivalent to a selected PLMN.

(2) Cell selection may always be based on a cell-defining system information block (CD-SSB) located in a synchronization raster.

(2-1) A UE may search NR frequency bands, and after identifying the strongest cell according to the CD-SSB for each frequency, read broadcasted cell system information to identify a PLMN.

(2-1-1) The UE may use stored information to search the respective frequencies in turn. Alternatively, the UE may use the stored information to shorten an initial cell selection search.

(3) A UE may attempt to identify a suitable cell, and if it cannot identify a suitable cell, it may attempt to identify an acceptable cell. If a suitable cell is found, the UE may camp on that cell and initiate a cell reselection procedure. Alternatively, if an acceptable cell is found, the UE may camp on that cell and initiate a cell reselection procedure.

(3-1) The suitable cell may be a cell whose measured cell attributes satisfy cell selection criteria. The cell's PLMN may be the selected PLMN, the cell's PLMN may be a registered PLMN, or the cell's PLMN of the cell may be an equivalent PLMN. Alternatively, the suitable cell may not be barred, may not be reserved, or may not be listed in a non-roaming tracking area list.

(3-2) The acceptable cell may be a cell whose measured cell attributes satisfy the cell selection criteria and is not barred.

(4) When transitioning from RRC connected mode or RRC inactive mode to RRC idle mode, the UE may camp on a cell selected as a result of cell selection according to a frequency allocated by RRC through a state transition message.

(5) For recovery from out of coverage, the UE may attempt to find a suitable cell based on the previously stored information or through an initial cell selection procedure. If no suitable cell is found on any frequency or radio access technology (RAT), the UE may attempt to find an acceptable cell.

(6) In multi-beam operations, a cell quality may be derived from beams corresponding to the same cell.

Cell reselection in RRC idle mode may follow the following principles.

(1) Cell reselection may always be based on a CD-SSB located in a synchronization raster.

(2) A UE may measure attributes of a serving cell and neighbor cells to perform a reselection process.

(2-1) Carrier frequencies for inter-frequency search and measurement of neighbor cells may be indicated to the UE.

(3) In cell reselection, a UE may identify a cell to camp on. For this, the UE may use cell reselection criteria, which are based on measurements of the serving cell and neighbor cells.

(3-1) Intra-frequency reselection may be based on cell ranking.

(3-2) Inter-frequency reselection may allow the UE to camp on the highest priority frequency available.

(3-3) A neighbor cell list may be provided by the serving cell.

(3-4) An excluded cell list may be provided by the serving cell.

(3-5) An allowed cell list may be provided by the serving cell.

In RRC connected mode, mobility support may support both cell-level mobility and beam-level mobility. The cell-level mobility may require explicit triggering by RRC signaling. In other words, the cell-level mobility may require a handover. On the other hand, the beam-level mobility support may not require explicit triggering by RRC signaling. Such beam-level mobility support may be achieved through intra-cell or inter-cell beam management.

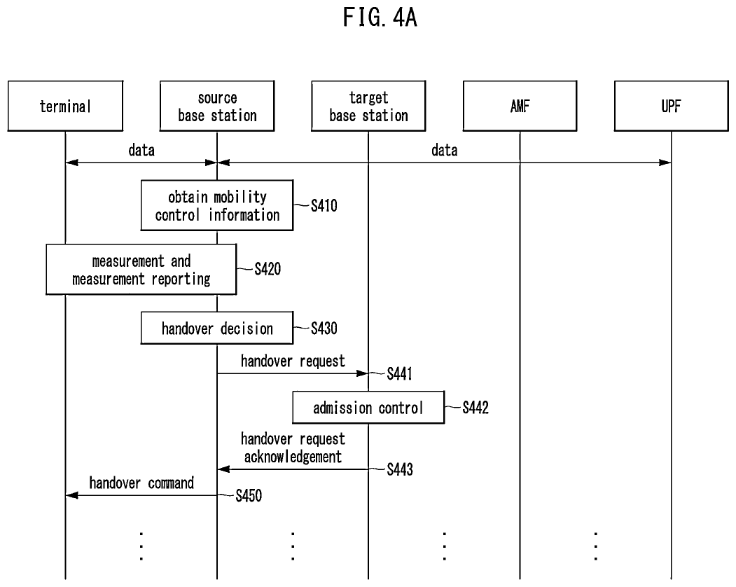

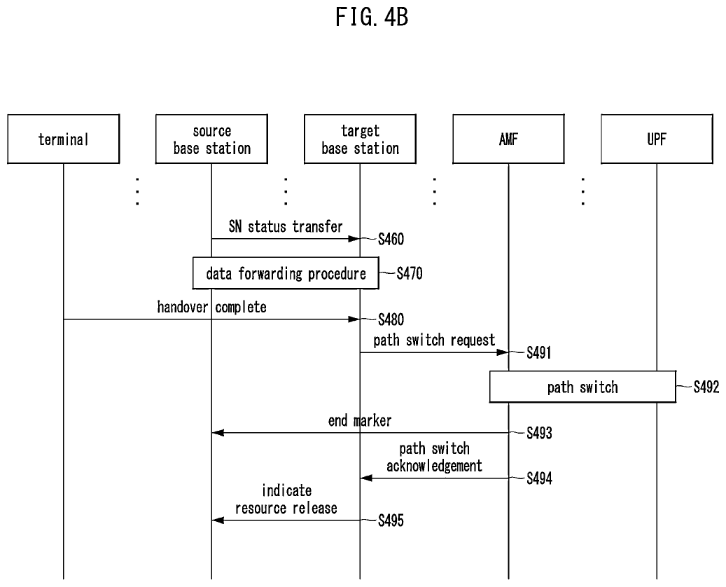

FIG. 4A and FIG. 4B are a sequence chart illustrating a first exemplary embodiment of a handover method.

Referring to FIG. 4A and FIG. 4B, an AMF/UPF handover procedure defined in new radio (NR) technical specification (TS) 38.300 of the 3rd generation partnership project (3GPP) is illustrated. A terminal may be connected to a source base station, which is a current serving cell, and may transmit and receive data for the terminal with a UPF of a core network. A procedure described below may be a procedure for the terminal to handover from the source base station to a target base station. The source base station may obtain mobility control information for the terminal. In step S410, the source base station may obtain information related to roaming and access restriction of the terminal, which is collected through a tracking area update procedure, through an RRC connection establishment procedure with the terminal and an information exchange procedure with an AMF of the core network, and may use the information for mobility control.

The source base station may transmit, to the terminal, control information for measurement and measurement reporting of the terminal, and the terminal may perform measurement and measurement reporting operations based on the received control information and transmit a measurement result report to the source base station (S420). The source base station may decide a handover of the terminal based on the measurement result report and radio resource management (RRM) information received from the terminal (S430).

If a handover of the terminal is decided in step S430, the source base station may transmit a handover request message to the target base station to instruct the target base station to prepare for the handover (S441). The handover request message may include information needed for the target base station to prepare for the handover. Upon receiving the handover request message, the target base station may perform admission control to decide whether to accept the handover of the terminal (S442). If it is decided to accept the handover of the terminal, the target base station may prepare for the handover of the terminal and transmit a handover request acknowledgement message, which is an acknowledgment message for the handover request message, to the source base station (S443). In this case, the handover request acknowledgement message may include information to be transmitted by the source base station to the terminal in step S450 to be described later. For example, the handover request acknowledgement message may include information on a random access resource to be used in an access procedure for the terminal to access the target base station.

The source base station receiving the handover request acknowledgement message may transmit a handover command message to the terminal (S450). In this case, the handover command message may be transmitted as an RRC connection reconfiguration message. In addition, the handover command message may include the information on the random access resource included in the handover request acknowledgement message received from the target base station.

The terminal receiving the handover command message may perform the handover immediately. Accordingly, the terminal may disconnect from the source base station and attempt to access the target base station. The terminal may attempt random access (RA) to the target base station (i.e. transmit a RACH) using the information on the random access resource included in the handover command message, and the target base station may transmit a random access response (RAR) in response to the RACH. The random access procedure is not illustrated in FIGS. 4A and 4B, and a detailed description thereon is omitted.

Meanwhile, the source base station may transmit a sequence number (SN) status transfer message to the target base station in order to transmit packet data convergence protocol (PDCP) protocol data unit (PDU) transmission/reception status information for the terminal (S460). Meanwhile, a data forwarding procedure between the source base station and the target base station may be performed. In step S470, the source base station may configure a data forwarding tunnel with the target base station. The source base station may transmit data to be transmitted to the terminal, which is received from the UPF, to the target base station through the configured forwarding tunnel. In addition, the source base station may transmit uplink data received from the terminal to the target base station through the configured forwarding tunnel. Here, the data forwarding tunnel may be configured on an X2 or Xn interface, which is a logical interface between the two base stations.

When the terminal accesses the target base station through the above-described random access procedure, the terminal may report that the handover procedure of the terminal is completed by transmitting an RRC connection reconfiguration complete message to the target base station (S480). When the handover procedure of the terminal is completed, the target base station may transmit a path switch request message to the AMF (S491), and the AMF may control the UPF to switch a path of downlink data transmitted to the terminal to the target base station (S492).

The UPF may switch the path of the downlink data for the terminal to the target base station, and the AMF may transmit an end marker to the source base station to notify that data transmission to the terminal through the path to the source base station has been stopped (S493). All subsequent downlink data for the terminal and uplink data of the terminal may be transmitted through the path between the target base station and the UPF. The AMF may transmit a path switch request acknowledgement message to the target base station (S494), and the target base station may transmit, to the source base station, a resource release indication message (e.g. UE Context Release) to indicate to release UE context information, thereby notifying that the handover procedure for the UE has been successfully completed (S495).

On the other hand, the terminal may execute a conditional handover (CHO) if one or more handover execution conditions are satisfied. In a conditional handover, the UE may receive a CHO configuration from the base station. Then, the UE may start evaluating the execution conditions of the conditional handover. The UE may stop evaluating the execution conditions when executing the conditional handover.

The following principles may be applied to the conditional handover.

(1) CHO configuration information may include a configuration of CHO candidate cell generated by a candidate base station and execution condition(s) generated by the source base station.

(2) The execution condition(s) may consist of one or two trigger conditions. For example, the trigger conditions may include CHO event A3 or A5. Only a single reference signal (RS) type is supported, and the trigger conditions may simultaneously configure up to two different trigger quantities (e.g. reference signal received power (RSRP), reference signal received luality (RSRQ), received signal strength indicator (RSSI), signal to interference noise ratio (SINR), etc.) for evaluating CHO execution condition(s) of a single candidate cell.

(3) Upon receiving a handover command before arbitrary CHO execution condition(s) are satisfied (i.e. without CHO configuration), the UE may execute the handover procedure regardless of any previously received CHO configuration.

(4) While performing the CHO, the UE may not monitor the source cell from a time it starts synchronizing with the target cell.

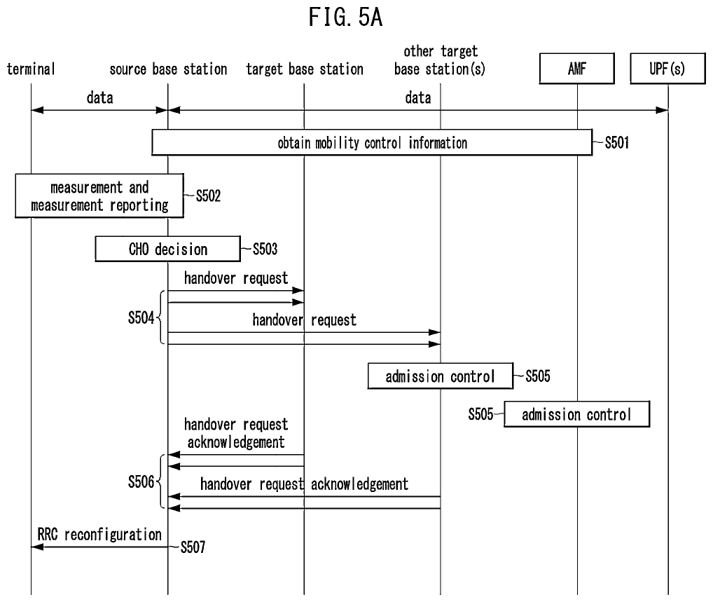

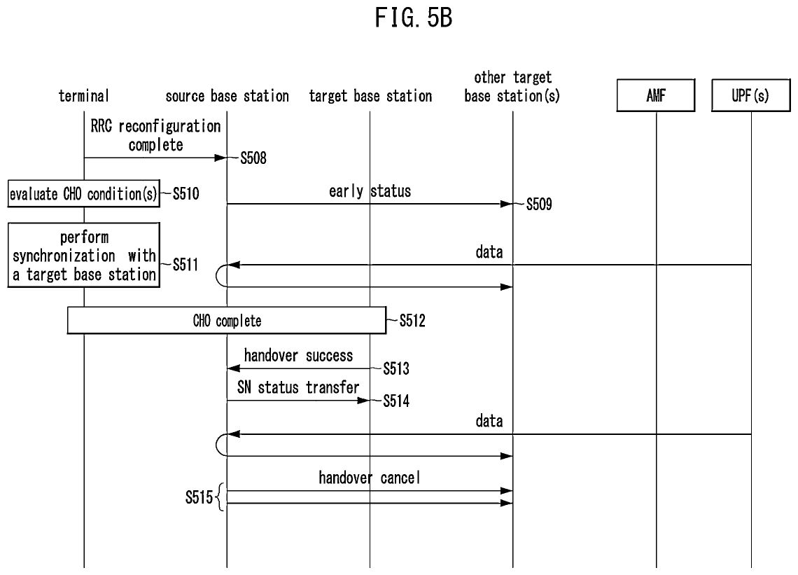

FIG. 5A and FIG. 5B are a sequence chart illustrating a first exemplary embodiment of a conditional handover method.

Referring to FIG. 5A and FIG. 5B, a terminal may be connected to a source base station, which is a current serving cell, and may transmit and receive data for the terminal with a UPF of a core network. A procedure described below may be described as a procedure for the terminal to perform a conditional handover from the source base station to a target base station. The source base station may obtain mobility control information for the terminal (S501). In step S501, the source base station may obtain information related to roaming and access restrictions of the terminal, which is collected through a tracking area update procedure, through an RRC connection establishment procedure with the terminal and an information exchange procedure with an AMF of the core network, and may use the information for mobility control.

The source base station may transmit, to the terminal, control information for measurement and measurement reporting of the terminal, and the terminal may perform measurement and measurement reporting operations based on the received control information and transmit a measurement result report to the source base station (S502). The source base station may decide a CHO of the terminal based on the measurement result report and RRM information received from the terminal (S503).

If the source base station decides to perform a CHO, the source base station may determine potential target base stations among neighbor base stations of the terminal and transmit a handover request message to the selected potential target base stations (S504). Here, the handover request message may include information specifying that the handover request message requests the CHO. The potential target base stations receiving the handover request message may perform admission control to determine whether to accept the handover request based on information on the terminal and current service information included in the handover request message (S505). If the handover request is approved, the potential target base stations may internally allocate internal resources, etc. for the handover of the corresponding terminal.

Then, potential target base stations may transmit handover request acknowledgement messages to the source base station (S506). Each of the handover request acknowledgement messages may include information on a radio connection reconfiguration message of the potential target base station, which includes radio configuration information allocated by the potential target base station for the handover of the terminal. The source base station receiving the handover request acknowledgement messages from the potential target base stations, may transmit an RRC reconfiguration message including the radio connection reconfiguration messages received from the potential target base stations to the terminal (S507). The terminal receiving the RRC reconfiguration message from the source base station may monitor cells of the potential target base stations while maintaining the connection state with the source base station. In this case, the terminal may transmit an RRC reconfiguration complete message to the source base station (S508). Then, the source base station may receive the RRC reconfiguration complete message from the terminal.

Meanwhile, the source base station may determine early data forwarding. If the source base station determines early data forwarding, the source base station may select a potential target base station to perform early data forwarding with. The source base station may transmit an early status message including information related to a sequence number (SN) of a PDCP packet to be transmitted in downlink to the potential target base station selected for data forwarding (S509). Then, the source base station may forward downlink user data to the potential target base station.

Meanwhile, the terminal may evaluate CHO condition(s) included in the RRC reconfiguration message (S510), and if a potential target base station cell satisfying the CHO condition(s) is found, the terminal may decide a handover to the potential target base station. The terminal may start a handover procedure for the decided target base station. In this case, the terminal may perform synchronization with the target base station while continuing to receive or transmit user data and control messages from and to the source base station according to its capability (S511). Then, the terminal, source base station, and target base station may perform a CHO complete process (S512).

Accordingly, the target base station may notify that the terminal has successfully completed the handover to the target base station by transmitting a handover success message to the source base station (S513). The source base station may transmit an SN status transfer message including information related of an SN of a PDCP packet to be transmitted to the target base station in downlink and information related to an SN of a PDCP packet received in uplink (S514). In addition, the source base station may forward downlink and uplink user data to the target base station. The user data may or may not be transferred in form of a PDCP packet including a PDCP SN. The target base station receiving the user data from the source base station may perform a downlink and uplink user data transmission service to the terminal. In this case, user data of a PDCP SN that the terminal has not received may be transmitted to the terminal according to PDCP status report information received from the terminal. The target base station may discard user data of a PDSN SN that the terminal has already received from the source base station. The source base station receiving the handover complete message from the target base station may transmit a handover cancel message to other potential target base stations except the target base station (S515). Then, the other target base stations may receive the handover cancel message from the source base station. The source base station and the potential target base stations receiving the handover cancel message may release the radio resources allocated for the corresponding terminal and context information of the corresponding terminal.

Meanwhile, Release 17 NTN specifications may apply the TN handover procedure based on Release 16. Therefore, mobility support in RRC idle mode and RRC inactive mode of NTN may be applied in the same manner as the method applied in RRC idle mode and RRC inactive mode of TN. Accordingly, multiple tracking area codes (TACs) per PLMN within an NR NTN cell may be broadcasted for mobility support in RRC idle mode and RRC inactive mode of NTN. Additionally, the UE may implicitly determine a network type (i.e. TN or NTN) based on presence of a ‘cell barred NTN’ included in a system information block (SIB) 1. NTN ephemeris information may be provided by an SIB19. The NTN ephemeris information may include NTN payload ephemeris of a serving cell. Information of neighbor cells may be provided optionally. Similarly, in Release 17 NTN, mobility support in RRC connected mode may apply the handover and conditional handover procedures of Release 16 TN. However, in NTN, the UE may additionally have the following as trigger conditions for executing a CHO to a candidate cell.
(1) RRM measurement-based event A4
(2) Time-based trigger condition (e.g. Event T1)
(3) Location-based trigger condition (e.g. Event D1)

Here, the time-based and location-based trigger conditions may always be configured together with one of the measurement-based trigger conditions. The mobility of NTN compared to TN may consider the following NTN environment.

(1) Low RSRP variation and UE measurement error: In TN, an RSRP value may vary greatly from a cell center to a cell edge. In contrast, in NTN, an RSRP value variation is small, so it may be difficult to support mobility based on measurement alone.

(2) Large number of handovers and unnecessary handover events: Handover overhead may increase in NTN due to large number of handovers due to mobility of LEO satellites and unnecessary handover events due to low RSRP variation.

(3) Low downlink SINR: In NTN, which usually operates at low SINR, low downlink SINR may cause frequent radio link failures (RLFs).

Considering the above-described NTN environment, Release 17 NTN has newly added the aforementioned location-based and time-based mobility support. However, the NTN mobility support in Release 17 has defined only the minimum specifications for operating NR-based NTN. In addition, the NTN mobility support in Release 17 may not be performance-optimized. Accordingly, standardizations for improving the performance of NTN mobility support in Release 17 may be in progress in Release 18 to address the following issues.

(1) Issue 1 may be to support mobility between NTN cells and TN-NTN in not only Earth fixed cells but also Earth moving cells.

(2) Issue 2 may be to achieve performance improvement of conditional handover.

(3) Issue 3 may be to address signaling overhead and random access saturation caused by simultaneous occurrence of many UE handovers.

(4) Issue 4 may address increased power consumption of the terminal.

Therefore, handover methods proposed in the present disclosure can reduce battery consumption of terminals in various NTN scenario environments. In addition, handover methods proposed in the present disclosure can reduce signaling overhead in situations where simultaneous mobility support of many UEs is required. In addition, handover methods proposed in the present disclosure can effectively support mobility terminals in the air.

Meanwhile, in a cell of a satellite or an outer cell of a multi-beam satellite, which has a low elevation angle, may not have a circular cell shape, but may have a shape similar to an ellipse. Accordingly, handover methods proposed in the present disclosure can solve a problem of distance-based measurement report events considering circular cell shapes in such actual satellite cell shapes. In addition, in case of terminals located in the air, the triggering conditions for distance-based measurement report events for cell reselection and handover may be different from those for terminals located on the ground. Handover methods proposed in the present disclosure can solve a problem caused by such differences. In addition, terminals located in the air may wish to maintain an NTN cell due to their altitude even within a TN cell area. However, the terminals may unintentionally perform reselection or handover from the TN cell area within the NTN cell to a TN cell due to the measurement report event triggering conditions for terrestrial terminals. Accordingly, the handover methods proposed in the present disclosure can solve this problem.

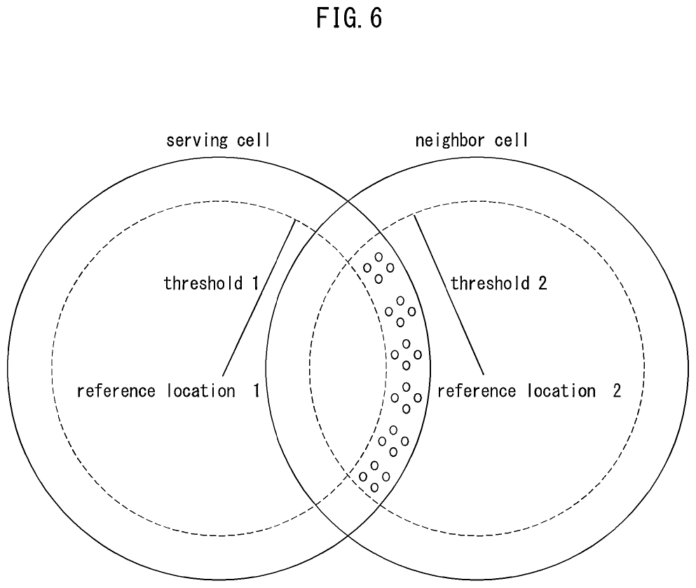

FIG. 6 is a conceptual diagram illustrating a first exemplary embodiment of a distance-based measurement report event triggering method.

Referring to FIG. 6, in a measurement report event triggering method, a measurement report event may be triggered based on a distance from a reference location and a distance threshold. The 3GPP Release 17 NTN specifications have added events D1 and T1, which are location-based and time-based event conditions, as measurement report triggering events for supporting cell reselection and handover of an Earth fixed cell. The measurement report trigger condition of the distance-based event D1 of the 3GPP Release 17 NTN specifications may be as follows. A terminal may enter a measurement report event if both conditions D1-1 and D1-2 are satisfied. In addition, the terminal may stop a measurement report event if either condition D1-3 or D1-4 is satisfied.
Event D1-1: Ml1−Hys>Thresh1 (Fixed regardless of UE location)
Event D1-2: Ml2+Hys<Thresh2 (Fixed regardless of UE location)
Event D1-3: Ml1+Hys<Thresh1 (Fixed regardless of UE location)
Event D1-4: Ml2−Hys>Thresh2 (Fixed regardless of UE location)

Here, Ml1 may be a distance between the terminal and a first reference location (i.e. reference location 1). Information on the first reference location may be included in measurement report configuration information for event D1. Ml2 may be a distance between the terminal and a second reference location (i.e., reference location 2). Information on the second reference location may be included in the measurement report configuration information for event D1. Hys may be a hysteresis parameter for event D1. Thresh1 may be a first distance threshold (i.e. threshold 1), and Thresh2 may be a second distance threshold (i.e. threshold 2). The first distance threshold and second distance threshold may be included in the measurement report configuration information for event D1.

The distance from the first reference location to the terminal may exceed the first threshold, and the distance from the second reference location to the terminal may be less than the second threshold. In this case, the terminal may trigger a measurement report event. In this case, the terminal located in the serving cell may trigger the measurement report event in an area indicated by ‘o’ in order to reselect or handover to a first neighbor cell. Therefore, the terminal may trigger the measurement report event for cell reselection or handover at a more appropriate timing than when triggering a measurement report event based on signal measurement. Accordingly, the terminal can reduce a measurement time for the measurement report, and thus reduce the battery consumption of the terminal.

The terminal may use the distance-based measurement report event triggering method in combination with the signal-based measurement report event (e.g. event A) triggering condition for more accurate triggering time determination. The distance-based measurement report event triggering method may work well in a circular cell. In other words, the distance-based measurement report event triggering method may work well in an Earth moving cell that forms one fixed beam vertically from the satellite toward the ground.

Meanwhile, when a satellite antenna forms a beam in a direction perpendicular to the ground, a circular satellite cell shape may be formed. In contrast, when a satellite antenna forms a beam while forming an elevation angle with the ground, an elliptical satellite cell shape may be formed. For example, when a satellite moves and steers a beam to create a fixed cell in a specific area, an elliptical satellite cell shape may be formed. Alternatively, as another example, when a satellite may not form a beam perpendicular to the ground and forms a low elevation angle, an elliptical satellite cell shape may be formed. Alternatively, as another example, when a satellite forms multiple beams, an elliptical satellite cell shape may be formed by the outermost beam.

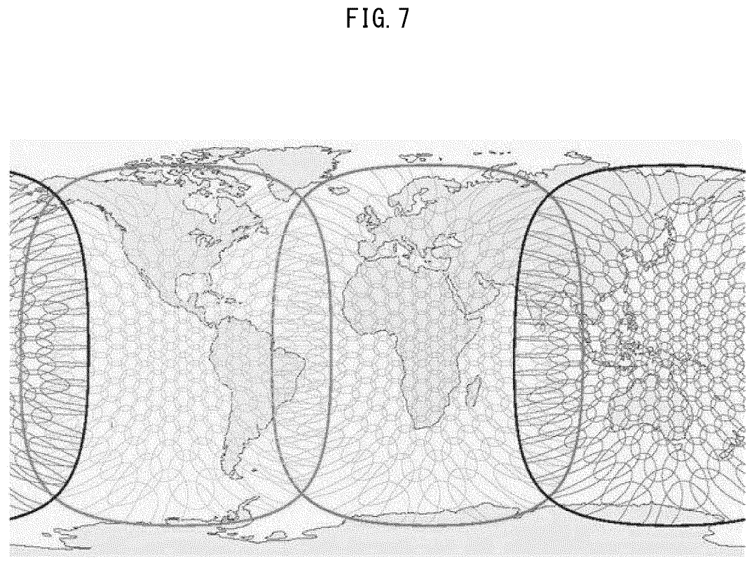

FIG. 7 is a conceptual diagram illustrating a first exemplary embodiment of a cell shape.

Referring to FIG. 7, when an elevation angle of a satellite is very low, a very distorted cell shape may be formed. In this case, the distance-based measurement report event triggering method may not work well with a reference location and a distance threshold.

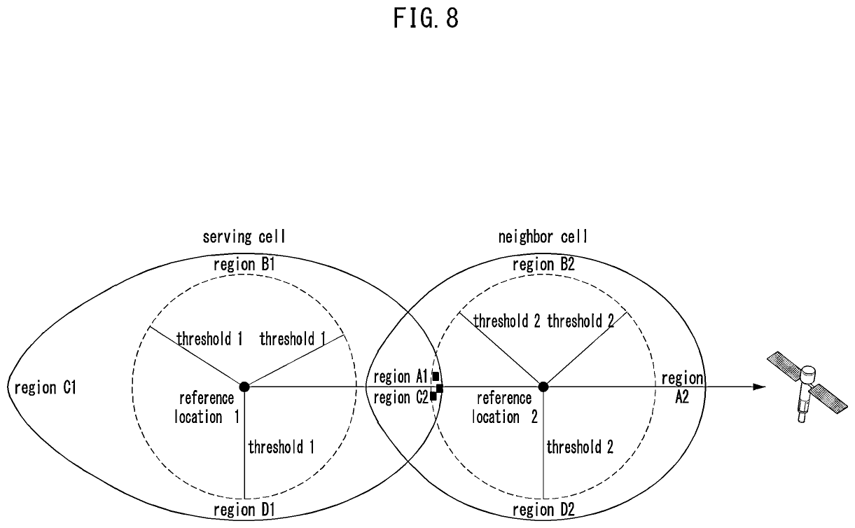

FIG. 8 is a conceptual diagram illustrating a second exemplary embodiment of a cell shape.

Referring to FIG. 8, a satellite may be located in the air with a low elevation angle on a straight line connecting a first reference location (i.e. reference location 1) and a second reference location (i.e., reference location 2). Alternatively, the satellite may form multiple beams while being located in the air on the straight line connecting the first reference location and the second reference location. As described above, when the satellite has a low elevation angle or forms multiple beams, it may have an elliptical cell shape. In this case, a left side of a serving cell and a neighbor cell may have a slightly more elongated shape. Due to the location of the satellite, the shape of the serving cell may be closer to an ellipse than that of the neighbor cell.

The first reference location may be at a center point of the serving cell. The first distance threshold (i.e. threshold 1) may be set by considering a distance from the first reference location to the closest boundary region (e.g. region B1 or D1) of the serving cell. In this case, for a boundary region (e.g. A1 or C1 region) of the serving cell that is farther from the first reference location, the first distance threshold, which is based on the closest boundary region (e.g. region B1 or D1), may be relatively smaller. Accordingly, the condition D1-1 may be easily satisfied by a terminal located in the region A1 or C1.

On the other hand, the second reference location may be at a center point of the neighbor cell. The second distance threshold (i.e. threshold 2) may be set by considering a distance from the second reference location to the closest boundary region (e.g. region B2 or D2) of the neighbor cell. In this case, for a boundary region (e.g. region A2 or C2) that is farther from the second reference location, the second distance threshold, which is based on the closest boundary region (e.g. region B2 or D2), may be relatively smaller. Accordingly, in the case of the neighbor cell, the condition D1-2 may be difficult to be satisfied by a terminal located in the region A2 or C2. As a result, a measurement report event may be triggered only in a narrow area with filled squares within the serving cell.

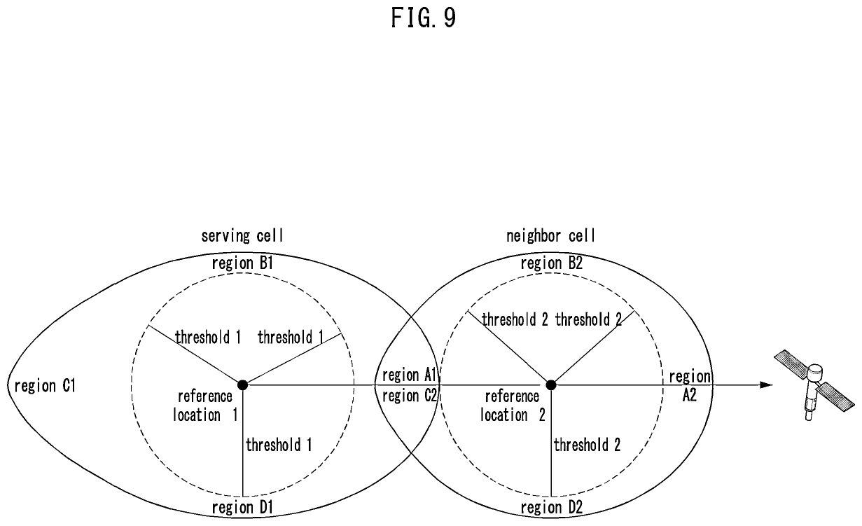

FIG. 9 is a conceptual diagram illustrating a third exemplary embodiment of a cell shape.

Referring to FIG. 9, a satellite may be located in the air with a low elevation angle on a straight line connecting a first reference location (i.e. reference location 1) and a second reference location (i.e., reference location 2). Alternatively, the satellite may form multiple beams while being located in the air on the straight line connecting the first reference location and the second reference location. As described above, when the satellite has a low elevation angle or forms multiple beams, it may have an elliptical cell shape. In this case, a left side of a serving cell and a neighbor cell may have a slightly more elongated shape. Due to the location of the satellite, the shape of the serving cell may be closer to an ellipse than that of the neighbor cell.

The first reference location may be at a center point of the serving cell. The first distance threshold (i.e. threshold 1) may be set by considering a distance from the first reference location to the closet boundary region (e.g. region B1 or D1) of the serving cell. In this case, for a boundary region (e.g. region A1 or C1) of the serving cell that is farther from the first reference location, the first distance threshold, which is based on the closest boundary region (e.g. region B1 or B2), may be relatively smaller. Accordingly, the condition D1-1 may be easily satisfied by a terminal located in the region A1 or C1.

On the other hand, the second reference location may be at a center point of the neighbor cell. The second distance threshold (i.e. threshold 2) may be set by considering a distance from the second reference location to the closest boundary region (e.g. region B2 or D2) of the neighbor cell. In this case, for a location (e.g. region A2 or C2) of the serving cell that is farther from the second reference location, the second distance threshold which is based on the closet boundary region (e.g. region B2 or D2), may be relatively smaller. Due to this, in the case of the neighbor cell, the condition D1-2 may be difficult to be satisfied by a terminal located in the region A2 or C2.

As a result, the measurement report event may not be triggered in the region of the serving cell. Accordingly, handover failures may occur frequently. Alternatively, RLFs may occur frequently. Therefore, the distance-based measurement report event triggering condition of Release 17 NTN may be changed when considering a cell pattern of an actual communication satellite such as a multi-beam satellite, a low-orbit satellite, etc.

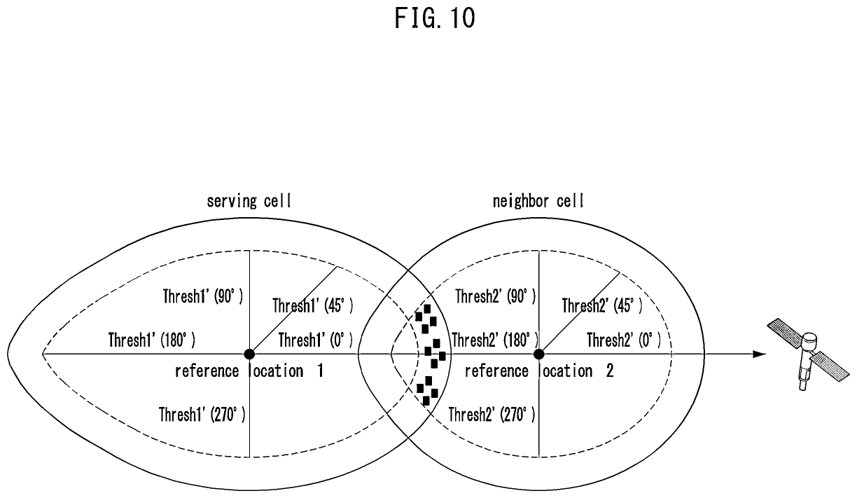

FIG. 10 is a conceptual diagram illustrating a fourth exemplary embodiment of a cell shape.

Referring to FIG. 10, a satellite may be located in the air with a low elevation angle on a straight line connecting a first reference location (i.e. reference location 1) and a second reference location (i.e., reference location 2). Alternatively, the satellite may form multiple beams while being located in the air to the right on the straight line connecting the first reference location and the second reference location. As described above, when the satellite has a low elevation angle or forms multiple beams, it may have an elliptical cell shape. In this case, a left side of a serving cell and a neighbor cell may have a slightly more elongated shape. Due to the location of the satellite, the shape of the serving cell may be closer to an ellipse than that of the neighbor cell.

The first reference location may be at a center point of the serving cell. The first distance threshold may vary based on an angle of a virtual line formed from the first reference location to a corresponding location, using the straight line connecting the first reference location and the second reference location as a reference line. In this case, the first distance threshold may be adjusted based on the angle of the virtual line in the serving cell. Accordingly, the first distance threshold may be referred to as a first adjusted distance threshold (i.e. Thresh 1′). Since the first adjusted distance threshold varies based on the angle of the line formed from the first reference location to the corresponding location, the first adjusted distance threshold may be expressed as Thresh 1′ (angle).

The second reference location may be at a center point of the neighbor cell. The second distance threshold may vary based on an angle of a virtual line formed from the first reference location to a corresponding location, using the straight line connecting the first reference location and the second reference location as a reference line. In this case, the second distance threshold may be adjusted based on the angle of the line in the neighbor cell. Accordingly, the second distance threshold may be referred to as a second adjusted distance (i.e. Thresh 2′). Since the second adjusted distance threshold varies based on the angle of the line formed from the second reference location to the corresponding location, the second adjusted distance threshold may be expressed as Thresh 2′ (angle).

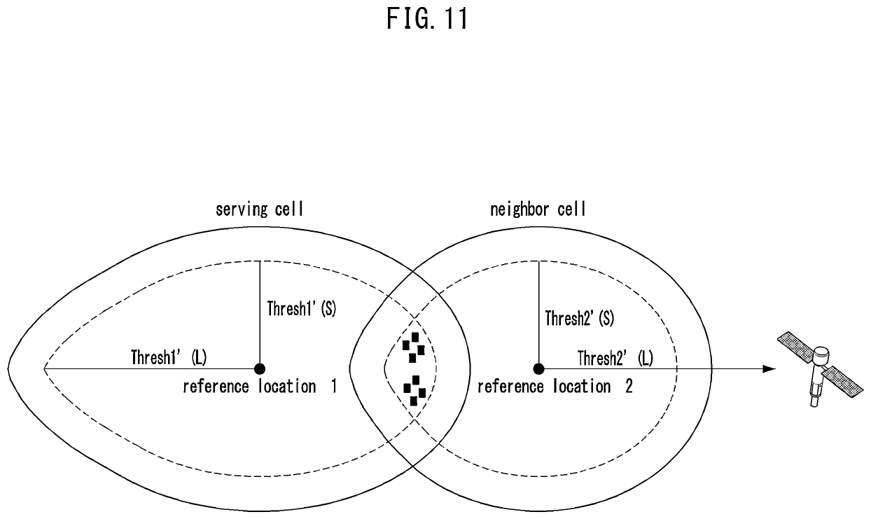

FIG. 11 is a conceptual diagram illustrating a fifth exemplary embodiment of a cell shape.

Referring to FIG. 11, a satellite may be located in the air with a low elevation angle on a straight line connecting a first reference location (i.e. reference location 1) and a second reference location (i.e., reference location 2). Alternatively, the satellite may form multiple beams while being located in the air on the straight line connecting the first reference location and the second reference location. As described above, when the satellite has a low elevation angle or forms multiple beams, it may have an elliptical cell shape. In this case, a left side of a serving cell and a neighbor cell may have a slightly more elongated shape. Due to the location of the satellite, the shape of the serving cell may be closer to an ellipse than that of the neighbor cell.

The first reference location may be at a center point of the serving cell. Using the straight line connecting the first reference location and the second reference location as a reference line, a line formed from the first reference location to a corresponding location may be used as a major axis, and an axis perpendicular to the major axis may be used as a minor axis to form the ellipse within the serving cell. In this case, the first distance threshold may be adjusted to be different at each point of the ellipse formed within the serving cell. Accordingly, the first distance threshold may be referred to as a first adjusted distance threshold (i.e. Thresh 1′).

The satellite may provide the terminal with a first major axis distance threshold (i.e. Thresh1′ (L)) corresponding to the major axis of the ellipse, and a first minor axis distance threshold (i.e. Thresh1′ (S)) corresponding to the minor axis of the ellipse. Then, the terminal may receive the first major axis distance threshold and the first minor axis distance threshold from the satellite. Then, the terminal may calculate a first adjusted distance threshold corresponding to each point of the ellipse based on the received first major axis distance threshold and the received first minor axis distance threshold, and apply it to the distance-based measurement report event triggering.

Meanwhile, the second reference location may be at a center point of the neighbor cell. Using the straight line connecting the first reference location and the second reference location as a reference line, a line formed from the first reference location to a corresponding location may be used as a major axis, and an axis perpendicular to the major axis may be used as a minor axis to form the ellipse within the neighbor cell. In this case, the second distance threshold may be adjusted to be different at each point of the ellipse formed within the neighbor cell. Accordingly, the second distance threshold value may be referred to as a second adjusted distance threshold (i.e. Thresh 2′).

The satellite may provide the terminal with the second major axis distance threshold (i.e. Thresh2′ (L)) corresponding to the major axis of the ellipse of the neighbor cell, and the second minor axis distance threshold (i.e. Thresh2′ (S)) corresponding to the minor axis of the ellipse of the neighbor cell. Then, the terminal may receive the second major axis distance threshold and the second minor axis distance threshold from the satellite. Then, the terminal may calculate a second adjusted distance threshold corresponding to each point of the ellipse based on the received second major axis distance threshold and the receiving second minor axis distance threshold and apply it to the distance-based measurement report event triggering.

Accordingly, the present disclosure proposes the following measurement report triggering conditions for the distance-based measurement report event D2.
The terminal may enter the measurement report event if both conditions D2-1 and D2-2 are satisfied.
The terminal may stop the measurement report event if one of conditions D2-3 or D2-4 is satisfied.
Event D2-1: Ml1−Hys or Ml1−Hys (varies depending on UE location)>Thresh1′(varies depending on UE location)
Event D2-2: Ml2+Hys or Ml2+Hys (varies depending on UE location)<Thresh2′ (varies depending on UE location)
Event D2-3: Ml1+Hys or Ml1+Hys (varies depending on UE location)<Thresh1′ (varies depending on UE location)
Event D2-4: Ml2−Hys or Ml2−Hys (varies depending on UE location)>Thresh2′ (varies depending on UE location)

Here, Ml1 may be a distance between the terminal and the first reference location. Information on the first reference location may be included in measurement report configuration information for event D2. In addition, Ml2 may be a distance between the terminal and the second reference location. Information on the second reference location may be included in the measurement report configuration information for event D2. Hys may be a hysteresis parameter for event D2. Hys may be fixed regardless of the location of the terminal. Alternatively, Hys may vary based on an angle of a virtual line formed from the reference location to a corresponding location using the straight line connecting the first reference location and the second reference location as a reference line. Thresh1′ may be the first adjusted distance threshold, and Thresh2′ may be the second adjusted distance threshold. The first adjusted distance threshold and the second adjusted distance threshold may be included in the measurement report configuration information for event D2. Thresh1′ may vary based on the angle of the line formed from the first reference location to the corresponding location, using the straight line connecting the first reference location and the second reference location as a reference line. In addition, Thresh2′ may vary based on the angle of the line formed from the second reference location to the corresponding location, using the straight line connecting the first reference location and the second reference location as a reference line. The Release 17 NTN may use fixed values for Thresh 1 and Thresh 2. However, the present disclosure may use adjusted values (i.e. Thresh1′ and Thresh2′) that vary depending on the location of the terminal as Thresh 1 and Thresh 2.

The satellite (i.e. satellite base station) may transmit information on all of two-dimensional boundary regions from the reference locations to the terminal in terms of handover or cell reselection efficiency. In this manner, it may be possible to express boundary regions for any type of cell shape. However, this method may have too much signaling overhead. Therefore, this method may be difficult to apply in practice. Therefore, the base station may transmit minimum information to the terminal so that the terminal can calculate or identify information on desired boundary regions.

In a first method, the satellite (i.e. the satellite base station) may configure the first reference location as a beam center region with the highest antenna gain within the serving cell, as shown in FIG. 10. Then, the satellite may provide the terminal with the first reference distance threshold as Thresh1′) (0° that exists on a line connecting the first reference location and the satellite. In this case, the terminal may identify its location through a global navigation satellite system (GNSS). Then, the terminal may receive information on the first reference location from the satellite. In addition, the terminal may receive satellite ephemeris information from the satellite. Accordingly, the terminal may calculate or infer the first adjusted distance threshold according to the location of the terminal, based on the satellite ephemeris information, information on the first reference location, location information of the terminal, and information on the first reference distance threshold.

In addition, the satellite may configure the second reference location as a beam center region with the highest antenna gain within the neighbor cell, as shown in FIG. 10. In addition, the satellite may provide the terminal with the second reference distance threshold as Thresh2′) (0° that exists on a line connecting the second reference location and the satellite. In this case, the terminal may identify its own location through the GNSS. In addition, the terminal may receive information on the second reference location from the satellite. In addition, the terminal may receive satellite ephemeris information from the satellite. Accordingly, the terminal may calculate or infer the second adjusted distance threshold according to the location of the terminal, based on the satellite ephemeris information, information on the second reference location, location information of the terminal, and information on the second reference distance threshold.

In the above-described method, the computational complexity may increase compared to the method used in Release 17 NTN. However, since it is a linear calculation, the computational complexity may not be that large. This method may be applied without increasing the signaling overhead in terms of the standard.

Meanwhile, in a second method, the satellite may provide the terminal with the first major axis distance threshold Thresh1′ (L) of the major axis of the ellipse within the serving cell and the first minor axis distance threshold Thresh1′ (S) of the minor axis of the ellipse within the serving cell as information on the first reference distance threshold, as shown in FIG. 11. Then, the terminal may calculate the first adjusted threshold of each point of the ellipse within the serving cell using the first major axis distance threshold and the first minor axis distance threshold. Alternatively, the satellite may provide the terminal with the first minor axis distance threshold and a ratio of the first minor axis distance threshold to the first major axis distance threshold as information on the first reference distance threshold. Then, the terminal may calculate the first minor distance threshold using the first major axis distance threshold and the ratio of the first minor axis distance threshold to the first major axis distance threshold, and calculate the first adjusted distance threshold at each point of the ellipse based on the first major axis distance threshold and the first minor distance threshold.

In addition, the satellite may provide the terminal with the second major axis distance threshold Thresh2′ (L) of the major axis of the ellipse within the neighbor cell and the second minor axis distance threshold Thresh2′ (S) of the minor axis of the ellipse within the neighbor cell as information on the second reference distance threshold, as shown in FIG. 11. Then, the terminal may calculate the second adjusted threshold of each point of the ellipse within the neighbor cell using the second major axis distance threshold and the second minor axis distance threshold. Alternatively, the satellite may provide the terminal with the second major axis distance threshold of the ellipse within the neighbor cell and a ratio of the second minor axis distance threshold to the second major axis distance threshold as information on the second reference distance threshold. Then, the terminal may calculate the second minor axis distance threshold using the second major axis distance threshold and the ratio of the second minor axis distance threshold to the second major axis distance threshold, and calculate the second adjusted distance threshold at each point of the ellipse based on the second major axis distance threshold.

Meanwhile, in a third method, the satellite may provide the terminal with the first major axis distance threshold Thresh1′ (L) of the major axis of the ellipse within the serving cell and the first minor axis distance threshold Thresh1′ (S) of the minor axis of the ellipse within the serving cell as information on the first reference distance threshold, as shown in FIG. 11. Then, the terminal may calculate the location of each point of the ellipse within the serving cell using the first major axis distance threshold and the first minor axis distance threshold. Alternatively, the satellite may provide the terminal with the first major axis distance threshold and a ratio of the first minor axis distance threshold to the first major axis distance threshold as information on the first reference distance threshold. Then, the terminal may calculate the first minor distance threshold using the first major axis distance threshold and the ratio of the first minor axis distance threshold to the first major axis distance threshold, and calculate a location of each point of the ellipse based on the first major axis distance threshold and the first minor axis distance threshold.

In this situation, the terminal may calculate its own location, and the terminal may calculate and determine whether the terminal exists within or outside the ellipse of the serving cell. If the terminal exists outside the ellipse of the serving cell, the terminal may determine that a distance from the first reference location to the terminal is greater than the distance threshold.

In addition, the satellite may provide the terminal with the second major axis distance threshold Thresh2′ (L) of the major axis of the ellipse inside the neighbor cell and the second minor axis distance threshold Thresh2′ (S) of the minor axis of the ellipse inside the neighbor cell as information on the second reference distance threshold, as shown in FIG. 11. Then, the terminal may calculate a location of each point of the ellipse inside the neighbor cell using the second major axis distance threshold and the second minor axis distance threshold. Alternatively, the satellite may provide the terminal with the second major axis distance threshold and a ratio of the second minor axis distance threshold to the second major axis distance threshold as information on the second reference distance threshold. Then, the terminal may calculate the second minor axis distance threshold using the second major axis distance threshold and the ratio of the second minor axis distance threshold to the second major axis distance threshold, and calculate a location at each point of the ellipse based on the second major axis distance threshold and the second minor axis distance threshold.

In this situation, the terminal may calculate its own location. The terminal may calculate and determine whether the terminal exists inside or outside the ellipse of the corresponding neighbor cell. If the terminal exists outside the ellipse of the neighbor cell, the terminal may determine that a distance from the second reference location to the terminal is greater than the distance threshold. The method of using the ellipse as described may easily determine whether an event trigger condition is satisfied by using information on the reference locations, major axis distance threshold, and minor axis distance threshold.

The above-described methods may be easily applied to an Earth fixed cell. In addition, the above-described methods may be applied to a case of an Earth moving cell for which a reference location that changes over time needs to be considered. In addition, the above-described methods may be applied to the distance-based measurement report event according to a reference location that changes over time in an Earth moving cell that is standardized in Release 18 NTN. For example, the above-described methods may be applied to a case that considers a sub-satellite point and a distance offset, which are currently being discussed. In addition, the above-described methods may be applied as they are to an Earth moving cell that uses a time stamp at a reference location and a time of broadcast.

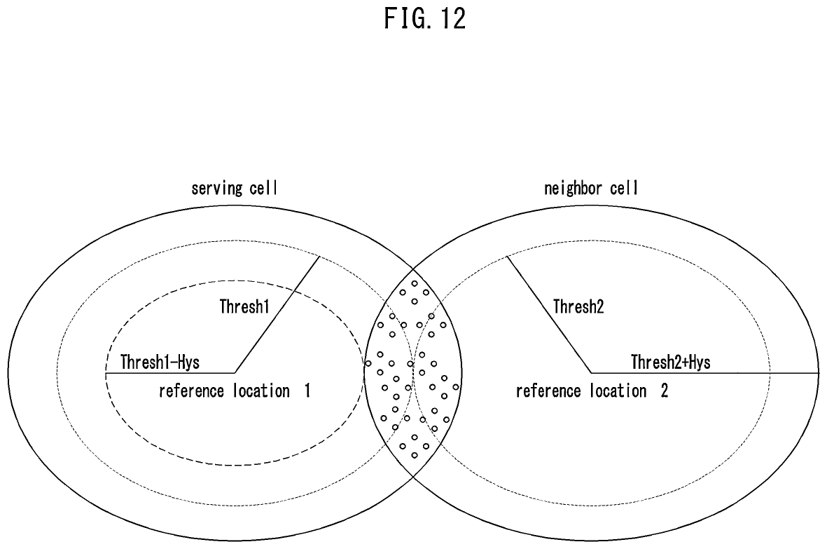

FIG. 12 is a conceptual diagram illustrating a sixth exemplary embodiment of a cell shape.

Referring to FIG. 12, a terminal may significantly increase Hys. Accordingly, the terminal may respond to triggering of measurement report events in non-circular serving cell and neighbor cell. A center point of the serving cell may be a first reference location (i.e. reference location 1), and a center point of the neighbor cell may be a second reference location (i.e. reference location 2). Distance regions of distance thresholds may be appropriately configured according to a value of Hys. Thresh1 may be a distance threshold for the serving cell, and Thresh2 may be a distance threshold for the neighbor cell.

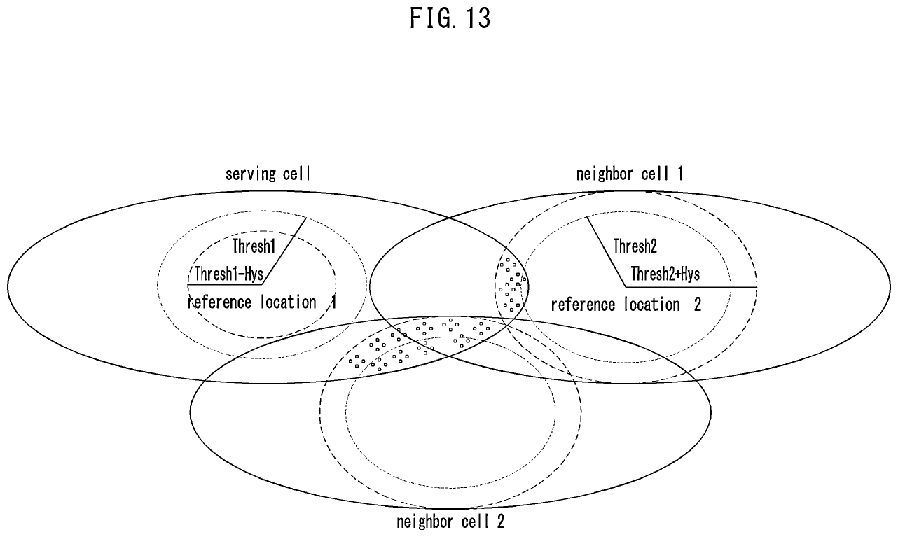

FIG. 13 is a conceptual diagram illustrating a seventh exemplary embodiment of a cell shape.

Referring to FIG. 13, a terminal may significantly increase Hys. Accordingly, the terminal may respond to triggering of measurement report events in non-circular serving cell and neighbor cell. However, if the cell is not circular, it may be difficult to configure appropriate distance regions of distance thresholds. A center point of the serving cell may be a first reference location (i.e. reference location 1), and a center point of the neighbor cell may be a second reference location (i.e. reference location 2). Thresh1 may be a distance threshold for the serving cell, and Thresh2 may be a distance threshold for the neighbor cell.

For example, assuming an elliptical serving cell, Hys+Thresh1 may be set to a minor axis length of the elliptical serving cell. In addition, assuming an elliptical neighbor cell, Hys+Thresh2 may be set to a minor axis length of the elliptical neighbor cell. In this case, regions satisfying the event triggering condition may be limited. Accordingly, cell reselection or handover performance may be degraded.

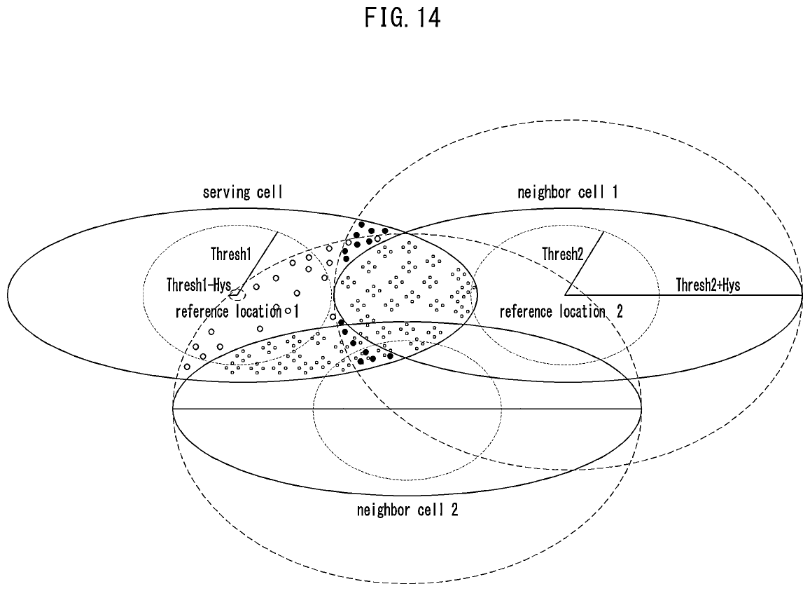

FIG. 14 is a conceptual diagram illustrating an eighth exemplary embodiment of a cell shape.

Referring to FIG. 14, a terminal may significantly increase Hys. Accordingly, the terminal may respond to triggering of measurement report events in non-circular serving cell and neighbor cell. However, if the cell is not circular, it may be difficult to configure appropriate distance regions of distance thresholds. A center point of the serving cell may be a first reference location (i.e. reference location 1), and a center point of the neighbor cell may be a second reference location (i.e. reference location 2). Thresh1 may be a distance threshold for the serving cell, and Thresh2 may be a distance threshold for the neighbor cell.

For example, assuming an elliptical serving cell, Hys+Thresh1 may be set to a major axis length of the elliptical serving cell. In addition, assuming an elliptical neighbor cell, Hys+Thresh2 may be set to a major axis length of the elliptical neighbor cell. In this case, regions satisfying the event triggering condition may be wide. In this case, measurement report events may be triggered in regions where cell reselection or handover is not required, such as regions indicated by black circles or relatively large diameter circles. Therefore, the circular-based threshold distance region configuration may be difficult to apply to non-circular cell shapes, regardless of a value of Hys.

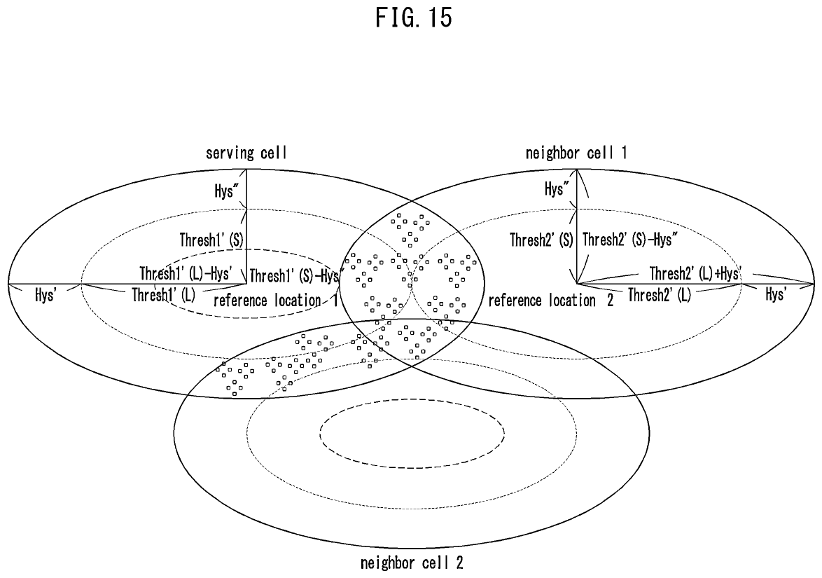

FIG. 15 is a conceptual diagram illustrating a ninth exemplary embodiment of a cell shape.

Referring to FIG. 15, a terminal may change Hys according to a major axis and a minor axis of an ellipse within a cell. Hys for the major axis of the ellipse may be Hys′, and Hys for the minor axis may be Hys “. Assuming an elliptical serving cell, Thresh1′ (L)−Hys' may be set to a major axis length of a small ellipse 1510, and Thresh1′ (S)−Hys” may be set to a minor axis length of the small ellipse 1510. Similarly, assuming an elliptical neighbor cell, Thresh2′ (L)+Hys' may be set to a major axis length of a large ellipse 1520, and Thresh2′ (S)+Hys” may be set to a minor axis length of the large ellipse 1520. In this case, regions satisfying the event triggering condition may be appropriately configured.

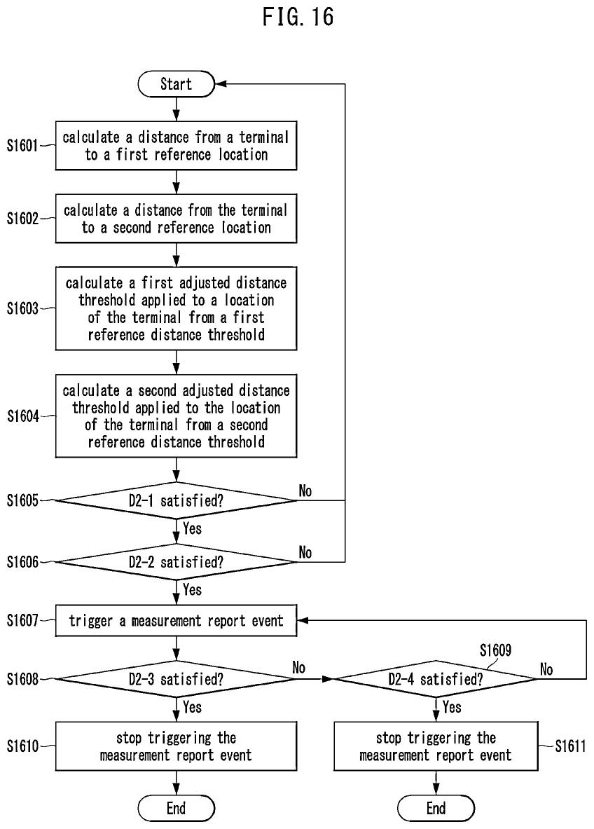

FIG. 16 is a conceptual diagram illustrating a second exemplary embodiment of a distance-based measurement report event triggering method.

Referring to FIG. 16, in a measurement report event triggering method, a terminal may calculate a distance Ml1 between the terminal and a first reference location (S1601). In addition, the terminal may calculate a distance Ml2 between the terminal and a second reference location (S1602). The terminal may calculate a first adjusted distance threshold Thresh 1′ applied at the location of the terminal from a first reference distance threshold Thresh1. In addition, the terminal may calculate a second adjusted distance threshold Thresh2′ applied at the location of the terminal from a second reference distance threshold Thresh2 (S1604).

Then, the terminal may check whether D2-1 (i.e. Ml1−Hys>Thresh1′) is satisfied (S1605). If a result of the checking indicates that D2-1 is not satisfied, the process from step S1601 may be performed again. On the other hand, if the result indicates that D2-1 is satisfied, the terminal may check whether D2-2 (i.e. Ml2+Hys<Thresh2′) is satisfied (S1606). If a result of the checking indicates that D2-2 is not satisfied, the process from step S1601 may be performed again. On the other hand, if the result indicates that D2-2 is satisfied, the terminal may trigger a measurement report event (S1607).

Then, the terminal may check whether D2-3 (i.e. Ml1−Hys<Thresh1′) is satisfied (S1608). If a result of the checking indicates that D2-3 is satisfied, the terminal may stop measurement report event triggering (S1609). On the other hand, if the result indicates that D2-3 is not satisfied, the terminal may check whether D2-4 (i.e. Ml2+Hys>Thresh2′) is satisfied (S1610). If a result of the checking indicates that D2-4 is not satisfied, the process from step S1607 may be performed again. On the other hand, if the result indicates that D2-4 is satisfied, the terminal may stop measurement report event triggering (S1611).

Meanwhile, in the case of the signal, distance, and time-based measurement report events for cell selection and handover between NTN-NTN, the measurement report event may be determined depending on whether the event triggering condition is satisfied by assuming the presence of the terminal in the terrestrial two dimensional space. In addition, in the case of the signal, distance, and time-based measurement report event for cell selection and handover between NTN-TN, the measurement report event may be determined depending on whether the event triggering condition is satisfied by assuming the presence of the terminal in the terrestrial two dimensional space. In this situation, the terminal such as UAM or aircraft may be located in the air. In this case, cell reselection or handover may not occur at a desired time with the existing measurement report event triggering condition.

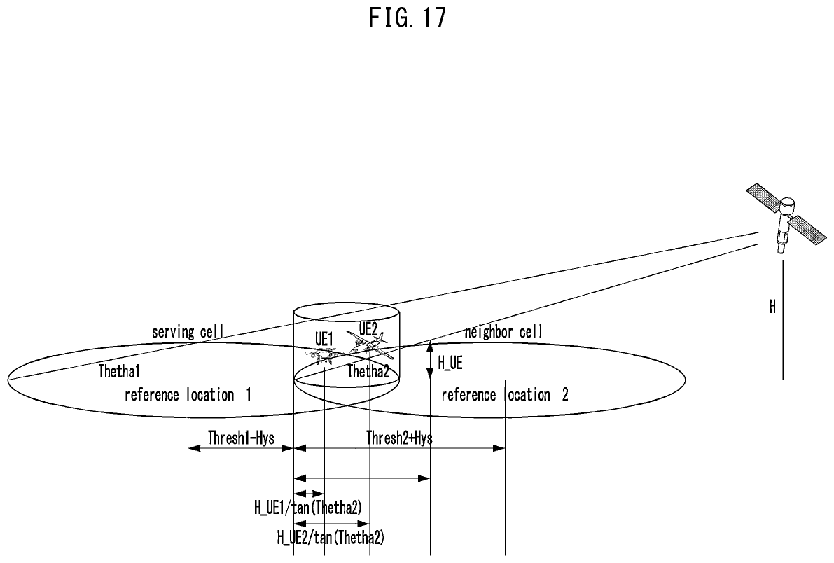

FIG. 17 is a conceptual diagram illustrating a tenth exemplary embodiment of a cell shape.

Referring to FIG. 17, in the case of the distance-based measurement report event of Release 17 NTN, a measurement report event may always occur regardless of the location of the terminal in a cylindrical region. In this situation, a first terminal (i.e. UE1) and a second terminal (i.e. UE2) may be located in the air. In this case, a distance-based measurement report event condition of Release 17 NTN may be satisfied by the first terminal and the second terminal. Accordingly, the first terminal and the second terminal may handover to a neighbor cell. However, the first terminal and the second terminal may belong to a beam area of the serving cell. Therefore, services through the existing serving cell may be more advantageous to the first terminal and the second terminal.

If an altitude of the terminal is not considered as described above, the cell reselection and handover based on the distance-based measurement report of the existing Release 17 NTN may not work properly for the terminal located in the air. Therefore, the terminal located in the air may use an altitude-based measurement report event along with the signal measurement, distance and time-based measurement report events. If the terminal uses the altitude-based measurement report event along with the existing measurement report events, the altitude-based measurement report event may enable accurate cell reselection and handover.

For example, an altitude H of a satellite may be 600 km. An angle Thetha1 may be 18 degrees, and an angle Thetha2 may be 30 degrees. A radius of the serving cell and the neighbor cell may be 50 km. The distance threshold Thresh may be 40 km. Hys may be 10 km. Under these conditions, in Release 17 NTN, the terminal may start triggering a measurement report event from a point 30 km away from the first reference location regardless of the altitude. However, according to the present disclosure, the terminal may start triggering a measurement report event from a point 47 km away from the first reference location when the terminal is operating in the air at an altitude of 10 km, like an aircraft. Accordingly, cell reselection and handover reflecting the characteristics of the actual satellite system may be possible. The altitude-based measurement report event triggering condition D3 for this may be as follows.
The terminal may enter a measurement report event if both conditions D3-1 and D3-2 are satisfied.
The terminal may stop a measurement report event if either condition D3-3 or D3-4 is satisfied.
Event D3-1: Ma1−Hys (fixed or variable depending on UE location)>H_Thresh1 (variable depending on UE location)
Event D3-2: Ma2+Hys (fixed or variable depending on UE location)<H_Thresh2 (variable depending on UE location)
Event D3-3: Ma1+Hys (fixed or variable depending on UE location)<H_Thresh1 (variable depending on UE location)
Event D3-4: Ma2−Hys (fixed or variable depending on UE location)>H_Thresh2 (variable depending on UE location)

Here, Ma1 may be an altitude difference between the terminal and a first reference altitude for event D3. The satellite may transmit the first reference altitude and 3D location information for the first reference altitude to the terminal by including them in configuration information for event D3. The terminal may receive the first reference altitude and the 3D location information for the first reference altitude from the base station.

Ma2 may be an altitude difference between the terminal and a second reference altitude for event D3. The satellite may transmit the second reference altitude and 3D location information for the second reference altitude to the terminal by including them in configuration information for event D3. The terminal may receive the second reference altitude and the 3D location information for the second reference altitude from the base station. Hys may be a hysteresis parameter for event D3, which may have a fixed value, as in Release 17 NTN. Alternatively, Hys may vary depending on the location of the terminal. In this case, Hys may be calculated and derived based on a reference Hys value in a location toward a specific location from the altitude reference location. Thresh1 may be a first distance threshold, and Thresh2 may be a second distance threshold. The first distance threshold and the second distance threshold may be included in measurement report configuration information for event D3. Thresh1 may vary based on an angle of a virtual line formed from the reference location to a corresponding location, using a straight line connecting the first reference location and the second reference location as a reference line. H_Thresh1 may be a first reference altitude threshold, and H_Thresh2 may be a second reference altitude threshold. The first reference altitude threshold and the second reference altitude threshold may be included in the measurement report configuration information for event D3. H_Thresh1 may vary depending on the location of the terminal based on an angle of a reference altitude line formed from the reference location to a corresponding location, using the straight line connecting the first reference location and the second reference location as a reference line. In this case, for example, the location of the first terminal UE1 may be H_UE1/tan (Thetha2) when the altitude of the first terminal is H-UE1. In addition, the position of the second terminal UE2 may be H_UE2/tan (Thetha2) when the altitude of the second terminal is H_UE2.

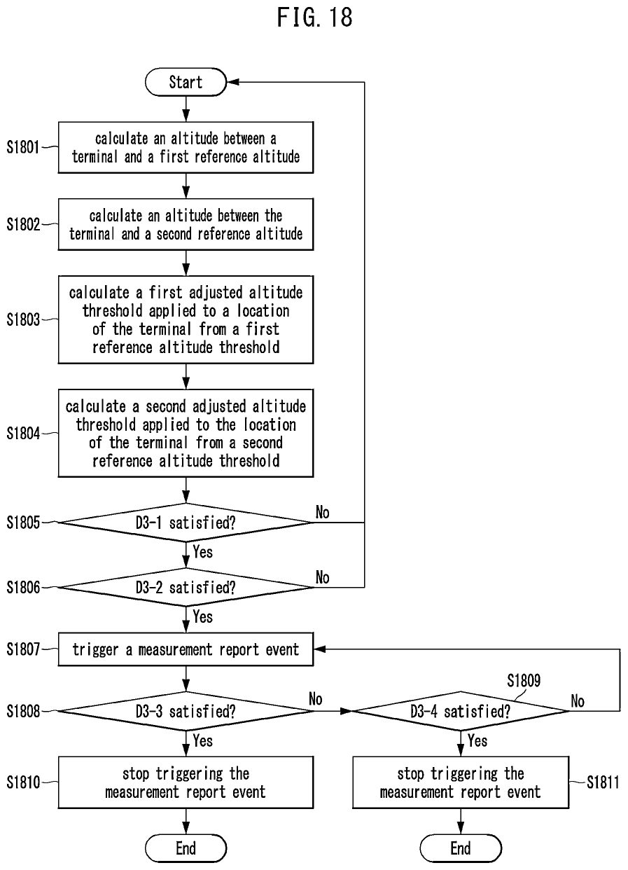

FIG. 18 is a flowchart illustrating a first exemplary embodiment of an altitude-based measurement report event triggering method.

Referring to FIG. 18, in a measurement report event triggering method, a terminal may calculate a distance Ma1 between the terminal and a first reference altitude (S1801). In addition, the terminal may calculate a distance Ma2 between the terminal and a second reference altitude (S1802). In addition, the terminal may calculate a first adjusted altitude threshold H_Thresh1′ applied at the location of the terminal from a first reference altitude threshold H_Thresh1 (S1803). In addition, the terminal may calculate a second adjusted altitude threshold H_Thresh2′ applied at the location of the terminal from a second reference altitude threshold H_Thresh2 (S1804).

Then, the terminal may check whether D3-1 (i.e. Ma1−Hys>H_Thresh1′) is satisfied (S1805). If a result of the checking indicates that D3-1 is not satisfied, the process from step S1801 may be performed again. On the other hand, if the result indicates that D3-1 is satisfied, the terminal may check whether D3-2 (i.e. Ma2+Hys<H_Thresh2′) is satisfied (S1806). If a result of the checking indicates that D3-2 is not satisfied, the process from step S1801 may be performed again. On the other hand, if the result indicates that D3-2 is satisfied, the terminal may trigger a measurement report event (S1807).

Then, the terminal may check whether D3-3 (i.e. Ma1−Hys<H_Thresh1′) is satisfied (S1808). If a result of the checking indicates that D3-3 is satisfied, the terminal may stop measurement report event triggering (S1809). On the other hand, if the result indicates that D3-3 is not satisfied, the terminal may check whether D3-4 (i.e. Ma2+Hys>H_Thresh2′) is satisfied (S1810). If a result of the checking indicates that D3-4 is not satisfied, the process from step S1807 may be performed again. On the other hand, if the result indicates that D3-4 is satisfied, the terminal may stop measurement report event triggering (S1811).

Meanwhile, in the case of the signal, distance, and time-based measurement report events for cell selection and handover between NTN-NTN, the measurement report event may be determined depending on whether the event triggering condition is satisfied by assuming the presence of the terminal in the terrestrial two dimensional space. In addition, in the case of the signal, distance, and time-based measurement report event for cell selection and handover between NTN-TN, the measurement report event may be determined depending on whether the event triggering condition is satisfied by assuming the presence of the terminal in the terrestrial two dimensional space. In this situation, the terminal such as UAM or aircraft may be located in the air. In this case, cell reselection or handover may not occur at a desired time with the existing measurement report event triggering condition.

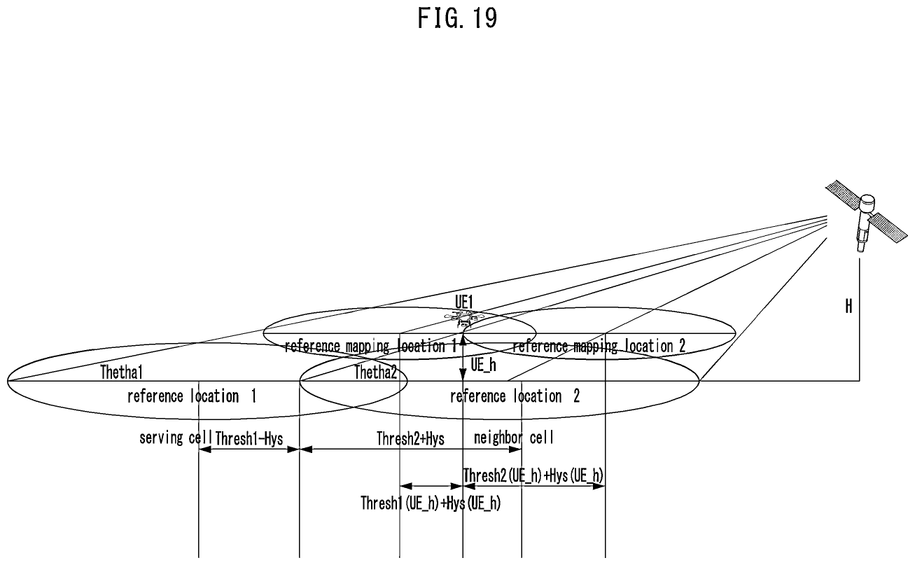

FIG. 19 is a conceptual diagram illustrating an eleventh exemplary embodiment of a cell shape.

Referring to FIG. 19, in the case of the distance-based measurement report event of Release 17 NTN, a measurement report event may always occur regardless of the location of the terminal in a cylindrical region. In this situation, a terminal (i.e. UE1) may be located in the air. For example, an altitude of the terminal may be UE_h. In this case, a distance-based measurement report event condition of Release 17 NTN may be satisfied by the terminal. Accordingly, the terminal may handover to a neighbor cell. However, the terminal may belong to a beam area of the serving cell. Therefore, services through the existing serving cell may be more advantageous to the terminal.

If the altitude of the terminal is not considered as described above, the cell reselection and handover based on the distance-based measurement report of the existing Release 17 NTN may not work properly for the terminal located in the air. Therefore, the terminal located in the air may use an altitude-based measurement report event along with the signal measurement, distance and time-based measurement report events. If the terminal uses the altitude-based measurement report event along with the existing measurement report events, the altitude-based measurement report event may enable accurate cell reselection and handover.

For example, an altitude H of a satellite may be 600 km. An angle Thetha1 may be 18 degrees, and an angle Thetha2 may be 30 degrees. A radius of the serving cell and the neighbor cell may be 50 km. The distance threshold Thresh may be 40 km. Hys may be 10 km. Under these conditions, in Release 17 NTN, the terminal may start triggering a measurement report event from a point 30 km away from the first reference location regardless of the altitude. However, according to the present disclosure, the terminal may start triggering a measurement report event from a point 47 km away from the first reference location when the terminal is operating in the air at an altitude of 10 km, like an aircraft. Accordingly, cell reselection and handover reflecting the characteristics of the actual satellite system may be possible.

For this purpose, the ground reference locations and thresholds may be newly mapped according to each altitude of the terminal. For example, the altitude of the terminal may be UE_h. Then, the first reference location used in the distance-based measurement report event condition may be easily mapped to a first reference mapping location moved by UE_h/tan (Thetha1) in the satellite direction. In addition, the second reference location used in the distance-based measurement report event condition may be easily mapped to a second reference mapping location moved by UE_h/tan (Thetha2) in the satellite direction.

In addition, the first reference distance threshold Thresh1 used in the distance-based measurement event condition may be applied by being scaled to a first reference mapping distance threshold Thresh1 (UE-h) having a value of (Thresh1×tan (Theta2)−UE_h)/tan (Thetha2)+UE_h/tan (arctan (H/(H/(tan (Thetha2)−Thresh1)) at the altitude UE_h. Here, H may be the altitude of the satellite.

In addition, the second reference distance threshold Thresh2 used in the distance-based measurement event condition may be applied by being scaled to a second reference mapping distance threshold Thresh2 (UE-h) having a value of (Thresh2×tan (Theta2)−UE_h)/tan (Thetha2)+UE_h/tan (arctan (H/(H/(tan (Thetha2)-Thresh2)))) at the altitude UE h.

In addition, the hysteresis value Hys used in the distance-based measurement event condition may be applied by being scaled to a mapping hysteresis value Hys (UE-h) having a value of (Hys×tan (Theta2)-UE_h)/tan (Thetha2)+UE_h/tan (arctan (H/(H/(tan (Thetha2)-Hys)) at the altitude UE_h. Then, the terminal may apply the existing NTN or the distance-based measurement report event condition of the present disclosure.

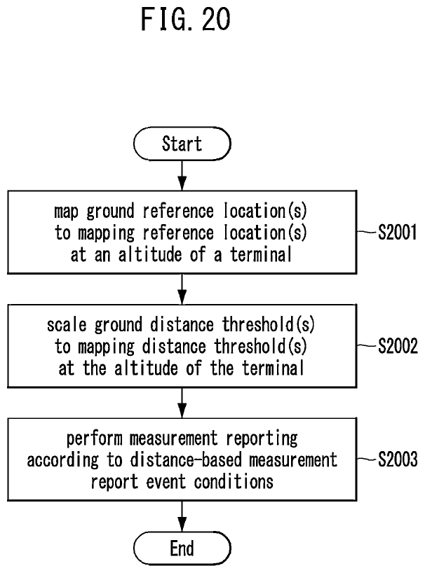

FIG. 20 is a flowchart illustrating a second exemplary embodiment of an altitude-based measurement report event triggering method.

Referring to FIG. 20, ground reference locations and thresholds may be newly mapped according to each altitude of the terminal. For example, the altitude of the terminal may be UE h. Then, the first reference location used in the distance-based measurement event condition may be easily mapped to a first reference mapping location moved by UE_h/tan (Thetha2) in the satellite direction. In addition, the second reference location used in the distance-based measurement event condition may be easily mapped to a second reference mapping location moved by UE_h/tan (Thetha2) in the satellite direction (S2001).

In addition, the first reference distance threshold Thresh1 used in the distance-based measurement event condition may be applied by being scaled to a first reference mapping distance threshold Thresh1 (UE-h) having a value of (Thresh1×tan (Theta2)−UE_h)/tan (Thetha2)+UE_h/tan (arctan (H/(H/(tan (Thetha2)-Thresh1) at the altitude UE_h. Here, H may be the altitude of the satellite. In addition, the second reference distance threshold Thresh2 used in the distance-based measurement event condition may be applied by being scaled to a second reference mapping distance threshold Thresh2 (UE-h) having a value of (Thresh2×tan (Theta2)−UE_h)/tan (Thetha2)+UE_h/tan (arctan (H/(H/(tan (Thetha2)-Thresh2) at the altitude UE h.

In addition, the hysteresis value Hys used in the distance-based measurement event condition may be applied by being scaled to a mapping hysteresis value Hys (UE-h) having a value of (Hys×tan (Theta2)-UE_h)/tan (Thetha2)+UE_h/tan (arctan (H/(H/(tan (Thetha2)-Hys)))) at the altitude UE_h. Then, the terminal may apply the existing NTN or the distance-based measurement report event condition of the present disclosure.

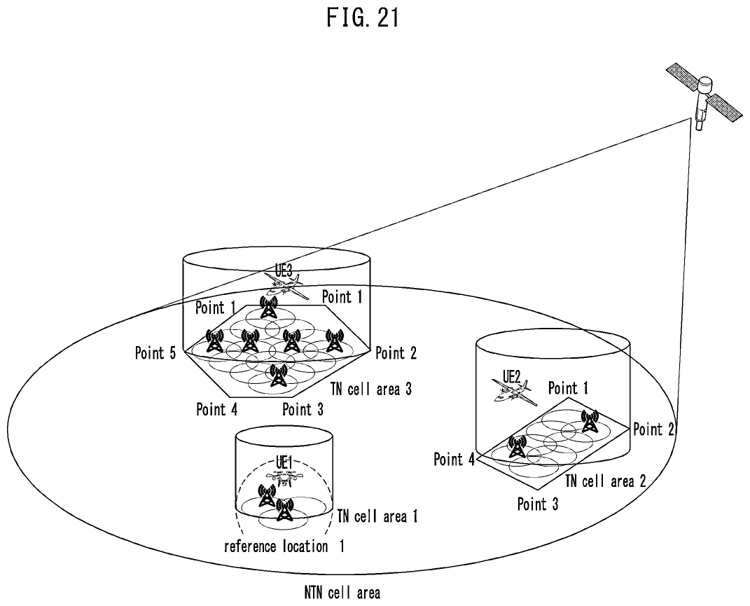

FIG. 21 is a conceptual diagram illustrating a twelfth exemplary embodiment of a cell shape.

Referring to FIG. 21, an NTN cell area may be circular, and a first TN cell area may be circular. The first TN cell area may be expressed by a first reference location and a first distance threshold. In addition, a second TN cell area may be rectangular. The second TN cell area may be expressed using polygonal information (i.e. rectangular information) and location information of points 1 to 4 according to the polygonal information. In addition, a third TN cell area may be pentagonal. The third TN cell area may be expressed using polygonal information (i.e. pentagonal information) and location information of points 1 to 5 according to the polygonal information.

According to Release 18 NTN specifications, measurement report event triggering, cell reselection and handover for TN cells may be performed near TN cell areas to reduce battery consumption of terminals during TN-NTN cell reselection and handover. For this purpose, a satellite base station may broadcast TN cell area information to terminals. Then, a terminal may receive the TN cell area information from the satellite base station. If the terminal determines that it is located within a TN cell area based on a GNSS and the received TN cell area information, the terminal may perform measurement report event triggering, cell reselection and handover. Here, Release 18 NTN specifications have not yet specified how to provide the TN cell area information. In this regard, like the first TN cell area, the satellite base station may provide the TN cell area information to the terminal using the reference location and distance threshold transmitted through the SIB19. Alternatively, the satellite base station may provide the TN cell area information as polygonal information to provide accurate TN cell area information like the second TN cell area and the third TN cell area.

These methods considered in the Release 18 NTN standard may all be based on the presence of a terminal in the terrestrial two dimensional space. However, there may be a terminal in the air, such as UAM and aircraft, that is difficult to service from the terrestrial networks. In such cases, it may be preferable not to perform TN cell reselection and handover even if the terminal is within a TN cell area. Therefore, the altitude-based measurement report event triggering condition D4 considering this situation may be as follows.
The terminal may enter a measurement report event if both conditions D4-1 and D2-2 are satisfied.
The terminal may stop a measurement report event if either condition D4-3 or D4-4 is satisfied.
Event D4-1: Ma1−Hys>Thresh1
Event D4-2: Ma2+Hys<Thresh2
Event D4-3: Ma1+Hys<Thresh1
Event D4-4: Ma2−Hys>Thresh2

Here, Ma1 may be an altitude difference between the terminal and a first reference altitude for event D4. The satellite may transmit the first reference altitude and 3D location information for the first reference altitude to the terminal by including them in configuration information for event D4. The terminal may receive the first reference altitude and the 3D location information for the first reference altitude from the base station.

Ma2 may be an altitude difference between the terminal and a second reference altitude for event D4. The satellite may transmit the second reference altitude and 3D location information for the second reference altitude to the terminal by including them in configuration information for event D4. The terminal may receive the second reference altitude and the 3D location information for the second reference altitude from the base station. Hys may be a hysteresis parameter for event D4, which may have a fixed value, as in Release 17 NTN. Alternatively, Hys may vary depending on the location of the terminal. In this case, Hys may be calculated and derived based on a reference Hys value in a location toward a specific location from the altitude reference location. Thresh1 may be a first distance threshold, and Thresh2 may be a second distance threshold. The first distance threshold and the second distance threshold may be included in measurement report configuration information for event D4. Thresh1 may vary based on an angle of a virtual line formed from the reference location to a corresponding location, using a straight line connecting the first reference location to the second reference location as a reference line.

H_Thresh1 may be a first reference altitude threshold, and H_Thresh2 may be a second reference altitude threshold. The first reference altitude threshold and the second reference altitude threshold may be included in the measurement report configuration information for event D4. H_Thresh1 may vary depending on the location of the terminal based on an angle of a line formed from the reference location to the corresponding location, using the straight line connecting the first reference location and the second reference location as a reference line. In this case, for example, the location of the first terminal UE1 may be H_UE1/tan (Thetha2) when the altitude of the first terminal is H-UE1. In addition, the position of the second terminal UE2 may be H_UE2/tan (Thetha2) when the altitude of the second terminal is H_UE2.

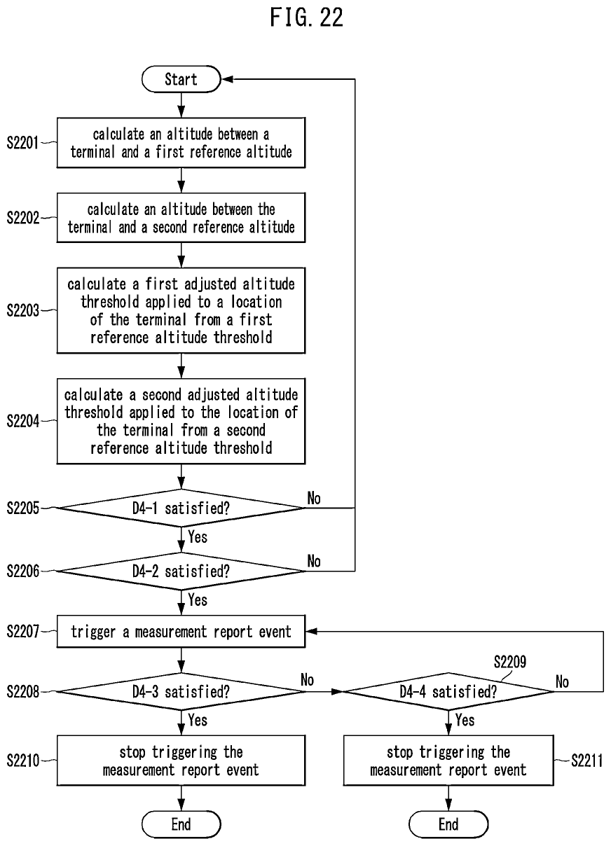

FIG. 22 is a flowchart illustrating a third exemplary embodiment of an altitude-based measurement report event triggering method.

Referring to FIG. 22, in a measurement report event triggering method, a terminal may calculate a distance Ma1 between the terminal and a first reference altitude (S2201). In addition, the terminal may calculate a distance Ma2 between the terminal and a second reference altitude (S2202). In addition, the terminal may calculate a first adjusted altitude threshold H_Thresh1′ applied at the location of the terminal from a first reference altitude threshold H_Thresh1 (S2203). In addition, the terminal may calculate a second adjusted altitude threshold H_Thresh2′ applied at the location of the terminal from a second reference altitude threshold H_Thresh2 (S2204).

Then, the terminal may check whether D4-1 (i.e. Ma1−Hys>H_Thresh1′) is satisfied (S2205). If a result of the checking indicates that D4-1 is not satisfied, the process from step S2201 may be performed again. On the other hand, if the result indicates that D4-1 is satisfied, the terminal may check whether D4-2 (i.e. Ma2+Hys<H_Thresh2′) is satisfied (S2206). If a result of the checking indicates that D4-2 is not satisfied, the process from step S2201 may be performed again. On the other hand, if the result indicates that D4-2 is satisfied, the terminal may trigger a measurement report event (S2207).

Then, the terminal may check whether D4-3 (i.e. Ma1−Hys<H_Thresh1′) is satisfied (S2208). If a result of the checking indicates that D4-3 is satisfied, the terminal may stop measurement report event triggering (S2209). On the other hand, if the result indicates that D4-3 is not satisfied, the terminal may check whether D4-4 (i.e. Ma2+Hys>H_Thresh2′) is satisfied (S2210). If a result of the checking indicates that D4-4 is not satisfied, the process from step S2207 may be performed again. On the other hand, if the result indicates that D4-4 is satisfied, the terminal may stop measurement report event triggering (S2211). In this manner, the terminal may handover from a TN cell to an NTN cell based on D4-1 to D4-4. In addition, the terminal may handover from an NTN cell to a TN cell based on D4-1 to D4-4.

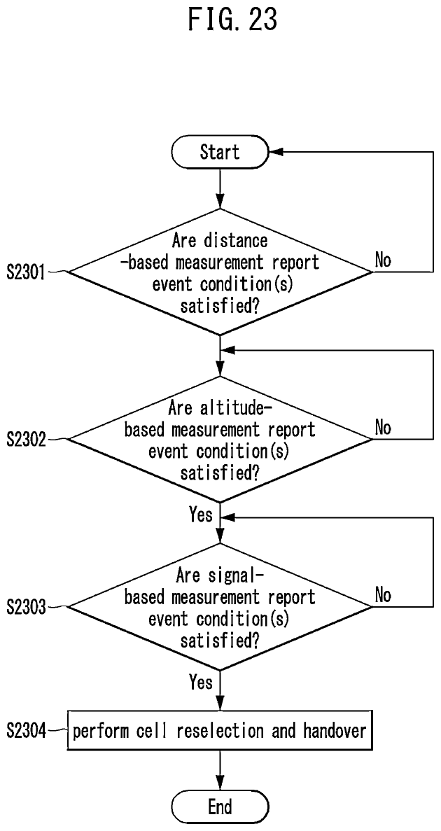

FIG. 23 is a flowchart illustrating a first exemplary embodiment of a cell selection method in a non-terrestrial network.

Referring to FIG. 23, in a cell selection method in a non-terrestrial network, a terminal may determine whether a distance-based measurement report event condition is satisfied (S2301). As a result of the determination, if a distance-based measurement report event condition is not satisfied, the terminal may wait. On the other hand, if a distance-based measurement report event condition is satisfied, the terminal may determine whether an altitude-based measurement report event condition is satisfied (S2302). Here, the distance-based measurement report event may be D1-1 and D1-2. Alternatively, the distance-based measurement report event may be D2-1 and D2-2. Alternatively, the altitude-based measurement report event may be D3-1 and D3-2. Alternatively, the altitude-based measurement report event may be D4-1 and D4-2.

Meanwhile, as a result of the determination, if the terminal does not satisfy an altitude-based measurement report event condition, the terminal may wait. On the other hand, the terminal may determine whether a signal-based measurement report event condition is satisfied if the altitude-based measurement report event condition is satisfied (S2303). Here, the signal-based measurement report event may be A3. Alternatively, the signal-based measurement report event may be A4. Here, the event A3 may be an event that satisfies a condition that a signal of a neighbor cell becomes larger by an offset than a signal of a serving cell. The event A4 may be an event that satisfies a condition that a signal of a neighbor cell becomes larger than a threshold.

As a result of the determination, the terminal may wait if a signal-based measurement report event condition is not satisfied. On the other hand, the terminal may perform cell reselection and handover if a signal-based measurement report event condition is satisfied (S2304).

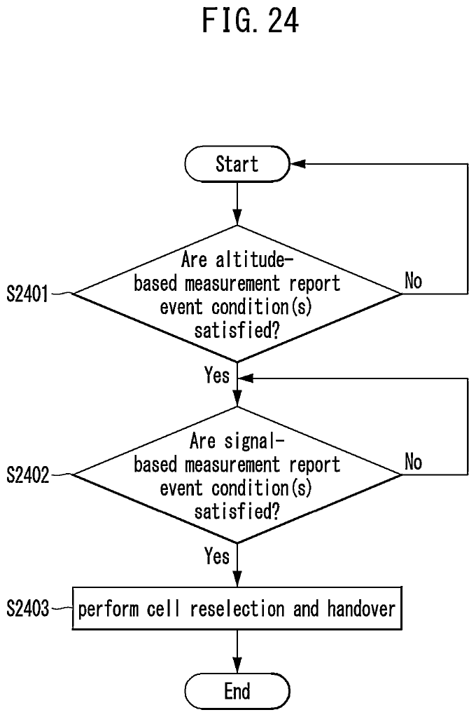

FIG. 24 is a flowchart illustrating a second exemplary embodiment of a cell selection method in a non-terrestrial network.

Referring to FIG. 24, in a cell selection method in a non-terrestrial network, a terminal may determine whether an altitude-based measurement report event condition is satisfied (S2401). Here, the altitude-based measurement report event may be D3-1 and D3-2. Alternatively, the altitude-based measurement report event may be D4-1 and D4-2.

Meanwhile, as a result of the determination, if the terminal does not satisfy an altitude-based measurement report event condition, the terminal may wait. On the other hand, if the terminal satisfies an altitude-based measurement report event condition, the terminal may determine whether a signal-based measurement report event condition is satisfied (S2402). Here, the signal-based measurement report event may be D3. Alternatively, the signal-based measurement report event may be D4.

As a result of the determination, if a signal-based measurement report event condition is not satisfied, the terminal may wait. On the other hand, if a signal-based measurement report event condition is satisfied, the terminal may perform cell reselection and handover (S2403).

Meanwhile, in FIGS. 23 and 24, the terminal first determines whether a distance-based measurement report event condition is satisfied, and then determines an altitude-based measurement report event, and then determines whether a signal-based measurement report event is satisfied, but this may not be limited thereto. In other words, the terminal may determine whether a signal-based measurement report event condition is satisfied, and then determine an altitude-based measurement report event, and the determine whether a distance-based measurement report condition is satisfied. Alternatively, after determining whether a distance-based measurement report event condition is satisfied, the terminal may determine a signal-based measurement report event, and then determine whether an altitude-based measurement report event condition is satisfied. Alternatively, after determining whether a distance-based measurement report event condition is satisfied, the terminal may a signal-based measurement report event, and then determine whether an altitude-based measurement report event condition is satisfied.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
calculating a first adjusted distance threshold by adjusting a first reference distance threshold of a serving cell, based on information on a first reference location of the serving cell, ephemeris information of a satellite, and a location of the terminal;
calculating a second adjusted distance threshold by adjusting a second reference distance threshold of a neighbor cell, based on information on a second reference location of the neighbor cell, the ephemeris information, and the location of the terminal;
performing a distance-based measurement reporting process by applying the first adjusted distance threshold and the second adjusted distance threshold; and
selecting a cell through the distance-based measurement reporting process.

2. The method according to claim 1, further comprising: before calculating of the first adjusted distance threshold,
receiving, from the satellite, the ephemeris information, information on the first reference location of the serving cell, and information on the first reference distance threshold of the serving cell; and
receiving global navigation satellite system (GNSS) signals from a GNSS to calculate the location of the terminal.

3. The method according to claim 1, further comprising: before calculating of the second adjusted distance threshold,
receiving, from the satellite, information on the second reference location of the neighbor cell, the ephemeris information, and information on the second reference distance threshold of the neighbor cell; and
receiving GNSS signals from a GNSS to calculate the location of the terminal.

4. The method according to claim 1, wherein the calculating of the first adjusted distance threshold comprises:
configuring a reference line between the first reference location and the satellite using information on the first reference location and the ephemeris information;
configuring a virtual line connecting the first reference location and the location of the terminal;
calculating an angle between the reference line and the virtual line; and
calculating the first adjusted distance threshold by adjusting the first reference distance threshold based on the calculated angle.

5. The method according to claim 1, wherein the calculating of the second adjusted distance threshold comprises:
configuring a reference line between the second reference location and the satellite using information on the second reference location and the ephemeris information;
configuring a virtual line connecting the second reference location and the location of the terminal;
calculating an angle between the reference line and the virtual line; and
calculating the second adjusted distance threshold by adjusting the second reference distance threshold based on the calculated angle.

6. The method according to claim 1, wherein the performing of the distance-based measurement reporting process comprises:
calculating a first distance between the location of the terminal and the first reference location;
calculating a second distance between the location of the terminal and the second reference location;
determining whether a first value obtained by subtracting a hysteresis value from the first distance exceeds the first adjusted distance threshold;
in response to the first value exceeding the first adjusted distance threshold, determining whether a second value obtained by adding the hysteresis value to the second distance is less than the second adjusted distance threshold; and
in response to the second value being less than the second adjusted distance threshold, triggering a measurement report event.

7. The method according to claim 6, wherein the performing of the distance-based measurement reporting process comprises:
recalculating the first distance between the location of the terminal and the first reference location;
determining whether a third value obtained by adding the hysteresis value to the recalculated first distance is less than the first adjusted distance threshold; and
in response to the third value being less than the first adjusted distance threshold, stopping triggering the measurement report event.

8. The method according to claim 6, wherein the performing of the distance-based measurement reporting process comprises:
recalculating the second distance between the location of the terminal and the second reference location;
determining whether a fourth value obtained by subtracting the hysteresis value from the recalculated second distance exceeds the second adjusted distance threshold; and
in response to the fourth value exceeding the first adjusted distance threshold, stopping triggering the measurement report event.

9. The method according to claim 6, wherein the hysteresis value varies depending on the location of the terminal.

10. A method of a terminal, comprising:
receiving, from a satellite, information on a first reference location of a serving cell, information on a first reference altitude threshold of the serving cell, information on a second reference location of a neighbor cell, and information on a second reference altitude threshold of the neighbor cell;
calculating a first altitude difference between an altitude of the terminal and the first reference location;
calculating a second altitude difference between the altitude of the terminal and the second reference location;
performing an altitude-based measurement reporting process based on the first reference altitude threshold, the second reference altitude threshold, the first altitude difference, and the second altitude difference; and
selecting a cell through the altitude-based measurement reporting process.

11. The method according to claim 10, wherein the performing of the altitude-based measurement reporting process comprises:
determining whether a first value obtained by subtracting a hysteresis value from the first altitude difference exceeds the first reference altitude threshold;
in response to the first value exceeding the first reference altitude threshold, determining whether a second value obtained by adding the hysteresis value to the second altitude difference is less than the second reference altitude threshold; and
in response to the second value being less than the second reference altitude threshold, triggering a measurement report event.

12. The method according to claim 11, wherein the performing of the altitude-based measurement reporting process comprises:
recalculating the first altitude difference between the altitude of the terminal and the first reference location;
determining whether a third value obtained by adding the hysteresis value to the recalculated first altitude difference is less than the first reference altitude threshold; and
in response to the third value being less than the first reference altitude threshold, stopping triggering the measurement report event.

13. The method according to claim 11, wherein the performing of the altitude-based measurement reporting process comprises:
recalculating the second altitude difference between the altitude of the terminal and the second reference location;
determining whether a fourth value obtained by subtracting the hysteresis value from the recalculated second altitude difference exceeds the second reference altitude threshold; and
in response to the fourth value exceeding the first reference altitude threshold, stopping triggering the measurement report event.

14. The method according to claim 10, further comprising: receiving, from the satellite, ephemeris information of the satellite, wherein the performing of the altitude-based measurement reporting process comprises:
configuring a reference altitude line by connecting the first reference location and the satellite using information on the first reference location and the ephemeris information;
setting a first adjusted altitude threshold by adjusting the first reference altitude threshold based on an angle between the reference altitude line and a ground and a location of the terminal;
setting a second adjusted altitude threshold by adjusting the second reference altitude threshold based on the angle between the reference altitude line and the ground and the location of the terminal; and
performing the altitude-based measurement reporting process based on the first adjusted altitude threshold, the second adjusted altitude threshold, the first altitude difference, and the second altitude difference.

15. The method according to claim 14, wherein the performing of the altitude-based measurement reporting process comprises:
determining whether a first value obtained by subtracting a hysteresis value from the first altitude difference exceeds the first adjusted altitude threshold;
in response to the first value exceeding the first adjusted altitude threshold, determining whether a second value obtained by adding the hysteresis value to the second altitude difference is less than the second adjusted altitude threshold; and
in response to the second value being less than the second adjusted altitude threshold, triggering a measurement report event.

16. A terminal comprising a processor, wherein the processor causes the terminal to perform:
calculating a first adjusted distance threshold by adjusting a first reference distance threshold of a serving cell, based on information on a first reference location of the serving cell, ephemeris information of a satellite, and a location of the terminal;
calculating a second adjusted distance threshold by adjusting a second reference distance threshold of a neighbor cell, based on information on a second reference location of the neighbor cell, the ephemeris information, and the location of the terminal;
performing a distance-based measurement reporting process by applying the first adjusted distance threshold and the second adjusted distance threshold; and
selecting a cell through the distance-based measurement reporting process.

17. The terminal according to claim 16, wherein in the performing of the distance-based measurement reporting process, the processor causes the terminal to perform:
calculating a first distance between the location of the terminal and the first reference location;
calculating a second distance between the location of the terminal and the second reference location;
determining whether a first value obtained by subtracting a hysteresis value from the first distance exceeds the first adjusted distance threshold;
in response to the first value exceeding the first adjusted distance threshold, determining whether a second value obtained by adding the hysteresis value to the second distance is less than the second adjusted distance threshold; and
in response to the second value being less than the second adjusted distance threshold, triggering a measurement report event.

18. The terminal according to claim 17, wherein in the performing of the distance-based measurement reporting process, the processor causes the terminal to perform:
recalculating the first distance between the location of the terminal and the first reference location;
determining whether a third value obtained by adding the hysteresis value to the recalculated first distance is less than the first adjusted distance threshold; and
in response to the third value being less than the first adjusted distance threshold, stopping triggering the measurement report event.

19. The terminal according to claim 16, wherein in the performing of the distance-based measurement reporting process, the processor causes the terminal to perform:
recalculating the second distance between the location of the terminal and the second reference location;
determining whether a fourth value obtained by subtracting the hysteresis value from the recalculated second distance exceeds the second adjusted distance threshold; and
in response to the fourth value exceeding the first adjusted distance threshold, stopping triggering the measurement report event.
